(19) United States
(12) Patent Application Publication
(10) Pub. No.: US 2014/0344233 A1
(43) Pub. Date: Nov. 20, 2014

(54) SERVER APPARATUS, AND DATA EXTRACTION METHOD

(71) Applicant: FUJITSU LIMITED, Kawasaki-shi (JP)

(72) Inventor: Hiroshi NAKAGAWA, Kanazawa (JP)

(73) Assignee: FUJITSU LIMITED, Kawasaki-shi (JP)

(21) Appl. No.: 14/248,892

(22) Filed: Apr. 9, 2014

(30) Foreign Application Priority Data
May 16, 2013 (JP) 2013-104470

(51) Int. Cl. G06F 17/30

(52) U.S. Cl. CPC G06F 17/30289
USPC 707/694

(57) ABSTRACT

A server apparatus performs first data extraction by first rule and second data extraction by a plurality of second rules, the plurality of second rules being generated from the first rule, and notifies an existence of notifying rule, when the plurality of second rules include a notifying rule that matches a specific condition.

### CROSS-REFERENCE TO RELATED APPLICATION

This application is based upon and claims the benefit of priority of the prior Japanese Patent Application No. 2013-104470, filed on May 16, 2013, the entire contents of which are incorporated herein by reference.

### FIELD

The embodiments discussed herein are related to a data extraction program and the like.

### BACKGROUND

In recent years, complex event processing (CEP) has been known as a technique for processing data which is collected every moment from various objects. In the complex event processing, data is extracted from a large amount of data based on preset conditions (rule), and analysis is performed based on the extracted data.

The analysis using CEP uses the data extracted by the preset rule. Here, while data (a large amount of data) to be processed changes from day to day, the set rule is based on recognition made at the time of setting. Hence, the set rule is not always appropriate. Therefore, when the set rule is not appropriate, it is desirable to change the rule to a more appropriate rule.
Japanese National Publication of International Patent Application No. 2007-531161

However, the conventional technique has a problem that it is difficult to change the set rule to an appropriate rule. Namely, it is difficult, in the first place, to directly determine whether the set rule is appropriate, by the number or content of pieces of data extracted by the rule. In addition, since the amount of data targeted for CEP is enormous, it is difficult to determine the appropriateness of the rule by directly referring to the data.

### SUMMARY

According to an aspect of an embodiment, a non-transitory computer-readable recording medium stores a data extraction program. The program causes a computer to execute a process for complex event The process includes performing first data extraction by first rule and second data extraction by a plurality of second rules, the plurality of second rules being generated from the first rule. The process includes notifying an existence of notifying rule, when the plurality of second rules include a notifying rule that matches a specific condition.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an overall configuration of a CEP system including a server apparatus, according to a first embodiment;

FIG. 2 is a diagram illustrating an example of the data structure of a rule table;

FIG. 3 is a diagram illustrating an example of the data structure of an optimization condition table;

FIG. 4 is a diagram illustrating an example of a specific process performed by the CEP system according to the first embodiment;

FIG. 5 is a flowchart illustrating the procedure of a data extraction process according to the first embodiment;

FIG. 6 is a diagram illustrating an overall configuration of a CEP system including a server apparatus, according to a second embodiment;

FIG. 7 is a diagram illustrating an example of the data structure of a rule internal table;

FIG. 8 is a diagram illustrating an example of a specific process performed by the CEP system according to the second embodiment;

FIG. 9 is a diagram illustrating another example of a specific process performed by the CEP system according to the second embodiment;

FIG. 10A is a flowchart illustrating the procedure of a data extraction process according to the second embodiment;

FIG. 10B is a flowchart illustrating the procedure of the data extraction process according to the second embodiment;

FIG. 11 is a diagram illustrating an overall configuration of a CEP system including a server apparatus, according to a third embodiment;

FIG. 12 is a diagram illustrating an example of the data structure of a rule internal table;

FIG. 13 is a diagram illustrating an example of a specific process performed by the CEP system according to the third embodiment;

FIG. 14A is a flowchart illustrating the procedure of a data extraction process according to the third embodiment;

FIG. 14B is a flowchart illustrating the procedure of the data extraction process according to the third embodiment;

FIG. 15 is a diagram illustrating an overall configuration of a CEP system including a server apparatus, according to a fourth embodiment;

FIG. 16 is a diagram illustrating an example of the data structure of a condition setting table;

FIG. 17 is a diagram illustrating an example of a specific process performed by the CEP system according to the fourth embodiment;

FIG. 18A is a flowchart illustrating the procedure of a data extraction process according to the fourth embodiment;

FIG. 18B is a flowchart illustrating the procedure of the data extraction process according to the fourth embodiment; and

FIG. 19 is a diagram illustrating an example of a computer that executes a data extraction program.

### DESCRIPTION OF EMBODIMENTS

Preferred embodiments of the present invention will be explained with reference to accompanying drawings. Note that the following describes the case of applying server apparatuses disclosed in the present application to a CEP system. Note also that the case of using the CEP system for stock trading prediction will be described. However, the server apparatuses disclosed in the present application are not limited thereto.

### [a] First Embodiment

Configuration of a CEP System According to a First Embodiment

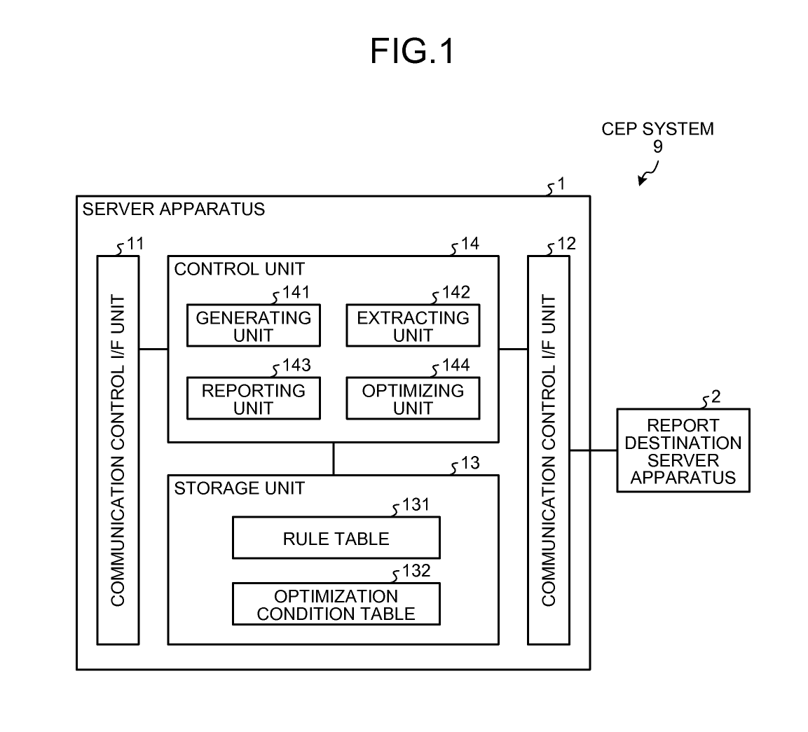

FIG. 1 is a diagram illustrating an overall configuration of a CEP system including a server apparatus, according to the first embodiment. As illustrated in FIG. 1, a CEP system 9 includes a server apparatus 1 and a report destination server apparatus 2. The server apparatus 1 is a physical server that performs complex event processing, and is, for example, a server computer provided in a data center or a company. Data that is collected from various objects is distributed to the server apparatus 1. The server apparatus 1 filters (extracts) a plurality of types of data received from various objects, according to a preset rule. Then, when the server apparatus 1 fails in extraction, the server apparatus 1 filters (extracts) the plurality of types of data received from the various objects, according to a plurality of rules (hereinafter, referred to as “derived rules”), each of which is automatically generated by changing a condition of the preset rule. Then, the server apparatus 1 reports the presence of a derived rule by which the extraction is succeeded to the report destination server apparatus 2.

The server apparatus 1 includes communication control I/F units 11 and 12, a storage unit 13, and a control unit 14. The communication control I/F units 11 and 12 are interfaces that control communication with a network. The communication control I/F unit 11 receives data distributed from various objects. For example, the communication control I/F unit 11 receives stock price information from a server of a dealer that provides a service to provide information including stock prices. The communication control I/F unit 11 receives currency exchange information from a server of a dealer that provides a service to provide information including currency exchange. The communication control I/F unit 11 receives gasoline price information from a server of a dealer that provides a service to provide information including gasoline prices. When a rule is matched, the communication control I/F unit 12 transmits content associated with the matched rule, to the report destination server apparatus 2.

The storage unit 13 is a storage apparatus such as a hard disk or an optical disk. Note that the storage unit 13 may be a data-rewritable semiconductor memory such as a RAM (Random Access Memory), a ROM (Read Only Memory), a flash memory, or an NVSRAM (Non Volatile Static Random Access Memory).

The storage unit 13 stores various types of information. For example, the storage unit 13 stores an OS (Operating System) and a program for performing various types of processes such as an extraction process and an optimization process (described later), which are executed by the control unit 14. The storage unit 13 further stores various types of data needed to execute the program which is executed by the control unit 14. For example, the storage unit 13 stores a rule table 131 and an optimization condition table 132.

The rule table 131 is a table that stores rules for filtering. As an example, a rule composed of a plurality of conditions is stored in the rule table 131 by a user to predict stock trading. Note that the data configuration of the rule table 131 will be described later.

The optimization condition table 132 is used to optimize a condition included in a rule stored in the rule table 131. Note that the data configuration of the optimization condition table 132 will be described later.

The control unit 14 includes an internal memory for storing a program in which various types of processing procedures are defined, and control data, by which various processes are performed. The control unit 14 corresponds to, for example, an electronic circuit of an integrated circuit, such as an ASIC (Application Specific Integrated Circuit) or an FPGA (Field Programmable Gate Array). Alternatively, the control unit 14 corresponds to an electronic circuit such as a CPU (Central Processing unit) or an MPU (Micro Processing Unit). The control unit 14 further includes a generating unit 141, an extracting unit 142, a reporting unit 143, and an optimizing unit 144.

The generating unit 141 generates derived rules where a condition of a preset rule is changed. For example, the generating unit 141 performs syntactic analysis on a preset rule to break down into a plurality of conditions included in the rule. Then, the generating unit 141 generates a derived rule where one of the plurality of broken-down conditions is negated. Then, the generating unit 141 stores the generated derived rule in the rule table 131. At this time, the generating unit 141 stores, in the rule table 131, report content which is reported to the user when the derived rule is matched, together with the generated derived rule.

As an example, it is assumed that the preset rule is “condition A and condition B and condition C”. The generating unit 141 breaks down the preset rule into “condition A”, “condition B”, and “condition C”. Then, the generating unit 141 generates, for condition A, a derived rule “(not condition A) and condition B and condition C” where condition A is negated. Then, the generating unit 141 stores, as report content to be reported to the user, the remaining, unsatisfied condition “condition A” together with the derived rule, in the rule table 131. In addition, the generating unit 141 generates, for condition B, a derived rule “condition A and (not condition B) and condition C” where condition B is negated. Then, the generating unit 141 stores, as report content to be reported to the user, the remaining, unsatisfied condition “condition B” together with the derived rule, in the rule table 131. In addition, the generating unit 141 generates, for condition C, a derived rule “condition A and condition B and (not condition C)” where condition C is negated. Then, the generating unit 141 stores, as report content to be reported to the user, the remaining, unsatisfied condition “condition C” together with the derived rule, in the rule table 131.

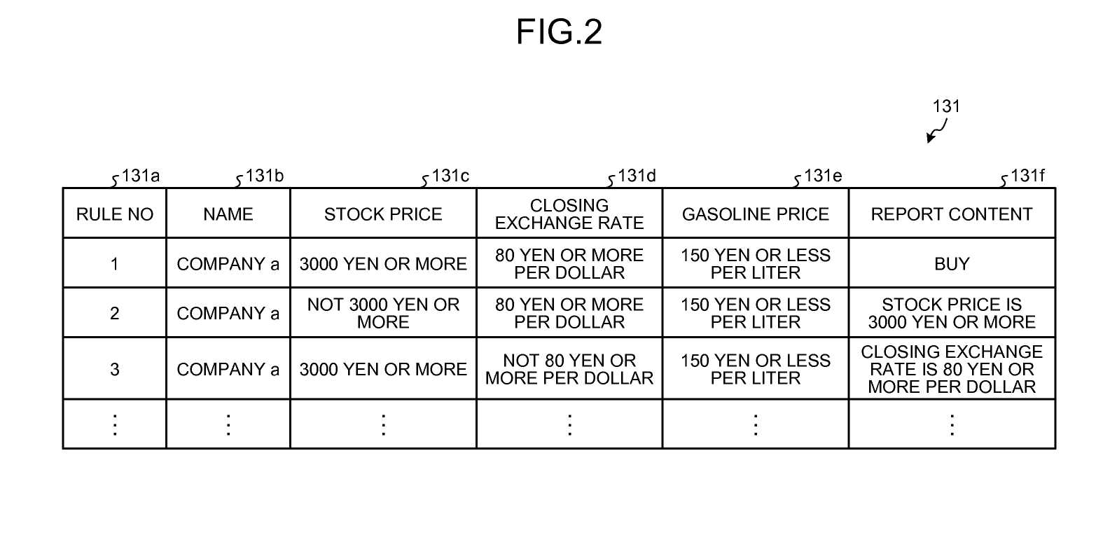

Now, the data structure of the rule table 131 will be described with reference to FIG. 2. FIG. 2 is a diagram illustrating an example of the data structure of the rule table. As illustrated in FIG. 2, the rule table 131 stores a rule No 131a, a name 131b, a stock price 131c, a closing exchange rate 131d, a gasoline price 131e, and report content 131f in association with one another. The rule No 131a is an identification number that uniquely identifies a rule. The name 131b indicates a name to which the rule is applied. The stock price 131c is a condition related to a stock price. The closing exchange rate 131d is a condition related to a closing exchange rate. The gasoline price 131e is a condition related to a gasoline price. The report content 131f is content that is reported to the user when all of the conditions are matched.

As an example, when the rule No 131a is “1”, “company a” is stored as the name 131b, “3000 yen or more” is stored as the stock price 131c, “80 yen or more per dollar” is stored as the closing exchange rate 131d, and “150 yen or less per liter” is stored as the gasoline price 131e. As the report content 131f, “buy” indicating that it is the timing of buying is stored. As another example, when the rule No 131a is “2”, “company a” is stored as the name 131b, “not 3000 yen or more” is stored as the stock price 131c, “80 yen or more per dollar” is stored as the closing exchange rate 131d, and “150 yen or less per liter” is stored as the gasoline price 131e. As the report content 131f, the remaining, unsatisfied condition “the stock price is 3000 yen or more” is stored.

Referring back to FIG. 1, the extracting unit 142 filters (extracts) a plurality of types of data received from various objects, according to the rules stored in the rule table 131. The various objects as used herein refer to objects related to stock trading. As an example, an object may be a stock price, or may be currency exchange, or may be a gasoline price. For example, the extracting unit 142 filters, for each rule stored in the rule table 131, a plurality of types of received data, based on a plurality of conditions included in the rule, and thereby detects a pattern that matches all conditions. Then, the extracting unit 142 extracts each of data that matches all conditions.

When data extraction by the preset rule fails, if the plurality of derived rules include a derived rule by which data extraction is succeeded, then the reporting unit 143 reports the presence of the derived rule to the report destination server apparatus 2. For example, the reporting unit 143 reports the remaining, unsatisfied condition among the conditions included in the preset rule. In addition, the reporting unit 143 reports the current value of data related to the preset rule. By this, the reporting unit 143 can report the presence of the derived rule including a condition that negates the remaining condition.

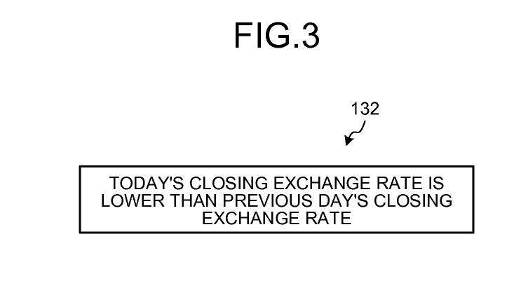

The optimizing unit 144 optimizes a condition included in the derived rule. For example, when received data matches an optimization condition stored in the optimization condition table 132, the optimizing unit 144 changes a corresponding condition value in the direction of change corresponding to the optimization condition. Now, the data structure of the optimization condition table 132 will be described with reference to FIG. 3. FIG. 3 is a diagram illustrating an example of the data structure of the optimization condition table. As illustrated in FIG. 3, the optimization condition table 132 stores an optimization condition. As an example, as the optimization condition, “today's closing exchange rate is lower than the previous day's closing exchange rate” is stored in the optimization condition table 132. In this case, as an example, the optimizing unit 144 updates the upper limit of the condition related to the stock price to the today's closing stock price. By this, the optimizing unit 144 can dynamically update the condition, according to a changing environment.

Example of a Specific Process Performed by the CEP System

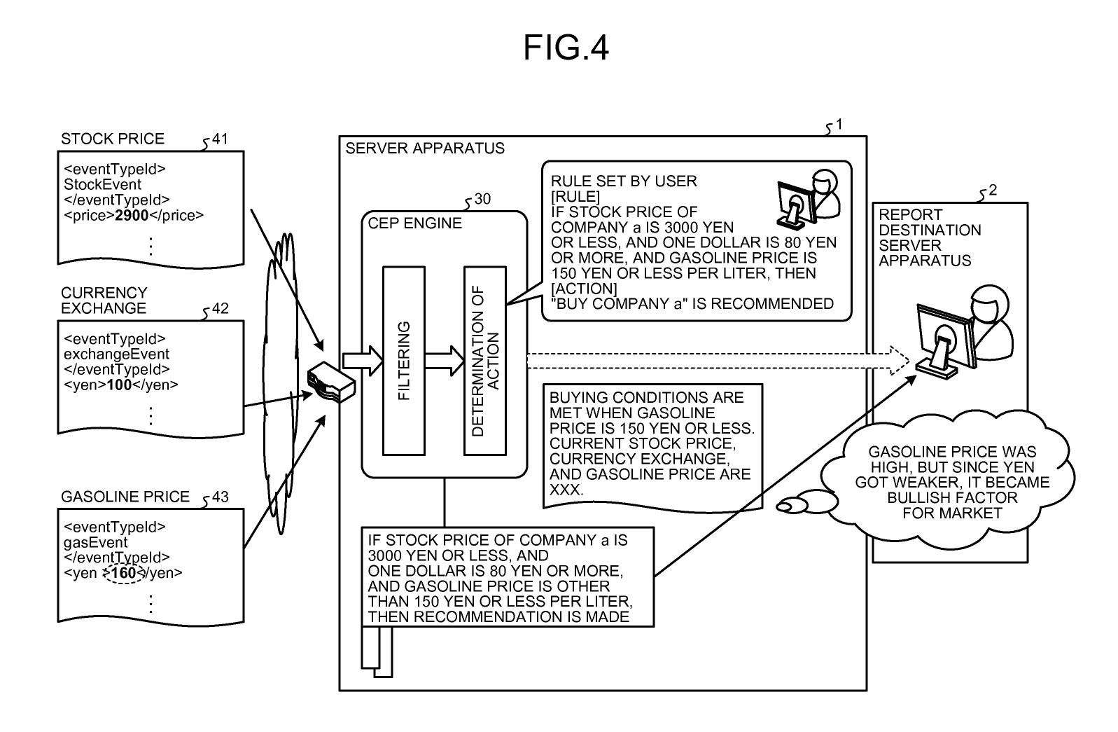

FIG. 4 is a diagram illustrating an example of a specific process performed by the CEP system according to the first embodiment. As illustrated in FIG. 4, stock price information 41, currency exchange information 42, and gasoline price information 43 are distributed as needed to the server apparatus 1 from a server of a dealer that provides a service to provide information including stock prices, currency exchange, and gasoline prices. In the example of FIG. 4, the stock price information 41, the currency exchange information 42, and the gasoline price information 43 have a data structure in XML (Extensible Markup Language) format. The stock price information 41 in the example of FIG. 4 indicates that the stock price is 2900 [yen]. The currency exchange information 42 in the example of FIG. 4 indicates that it is 100 [yen]. The gasoline price information 43 in the example of FIG. 4 indicates that it is 160 [yen].

In the server apparatus 1, a CEP engine 30 operates. The CEP engine 30 is included in the control unit 14, and is software that implements complex event processing. The software that implements complex event processing includes, for example, Esper.

Here, as a rule preset by the user, “the stock price of company a is 3000 yen or less (condition A) and the currency exchange is 80 yen or more per dollar (condition B) and the gasoline price is 150 yen or less per liter (condition C)” is set on the server apparatus 1. As an action taken when the rule is matched, a recommendation of “buy company a” is set. Furthermore, as a derived rule which is generated from the rule preset by the user, “the stock price of company a is 3000 yen or less (condition A) and the currency exchange is 80 yen or more per dollar (condition B) and the gasoline price is not 150 yen or less per liter (not condition C)” is set.

Such a server apparatus 1 receives the distributed stock price information 41, currency exchange information 42, and gasoline price information 43. The CEP engine 30 filters the received stock price information 41, currency exchange information 42, and gasoline price information 43, based on the plurality of conditions of the set rules, and thereby detects a pattern that matches all conditions. Then, when the conditions are matched, the CEP engine 30 recommends content associated with the matched rule to the report destination server apparatus 2.

In the example of FIG. 4, in the server apparatus 1, in the case of the rule preset by the user, condition A and condition B are matched, but condition C is not matched. On the other hand, in the server apparatus 1, in the case of the derived rule, all conditions, condition A, condition B, and (not condition C), are matched. Hence, the server apparatus 1 recommends, for example, “buying conditions are met when the gasoline price is 150 yen or less. The current stock price is 2900 yen, currency exchange is 100 yen, and gasoline price is 160 yen.” to the report destination server apparatus 2.

By this, the server apparatus 1 can reveal the presence of the derived rule including the condition “the gasoline price is 150 yen or more”. As a result, the report destination server apparatus 2 can grasp the remaining condition of the current rule, according to the recommendation. Namely, in the report destination server apparatus 2, the user can grasp that the condition of the gasoline price is not satisfied, and can review the current rule, which in turn can prevent missing of a stock trading opportunity.

Procedure of a Data Extraction Process

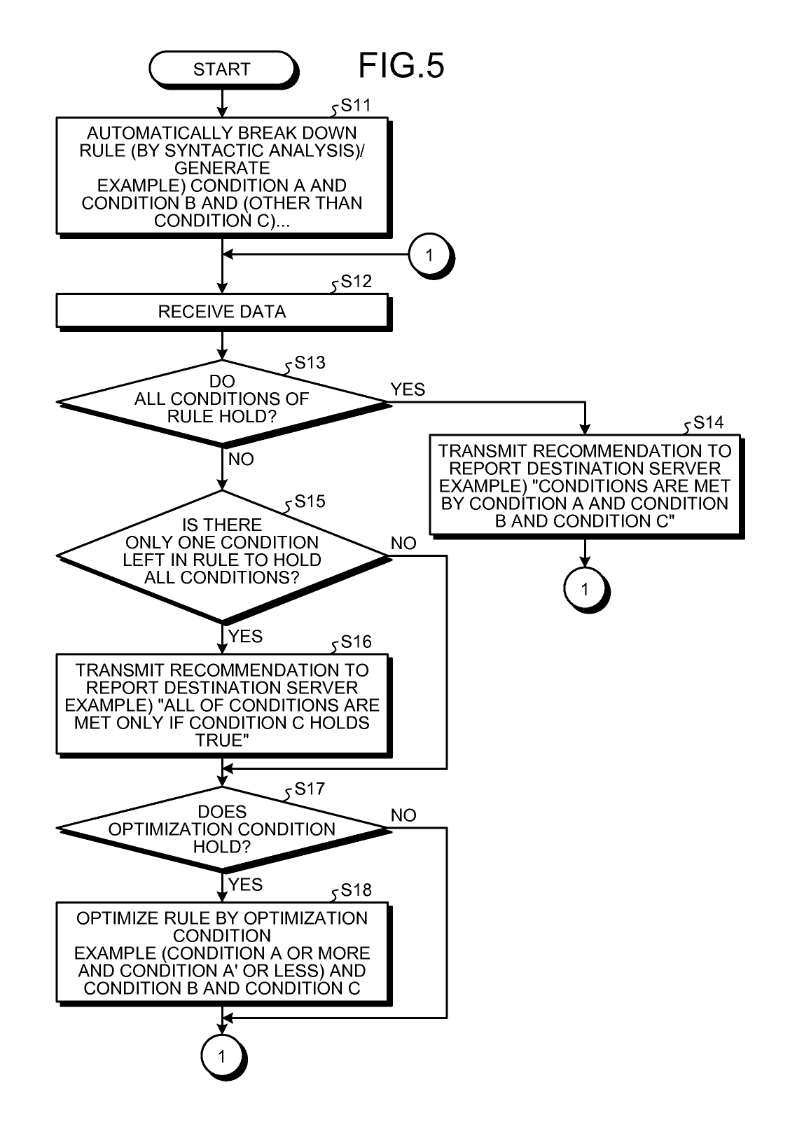

Next, with reference to FIG. 5, the procedure of a data extraction process will be described. FIG. 5 is a flowchart illustrating the procedure of a data extraction process according to the first embodiment. Note that a preset rule is stored in the rule table 131. It is assumed that the preset rule is, as an example, “condition A and condition B and condition C”. Note also that an optimization condition is stored in the optimization condition table 132. It is assumed that the optimization condition is, as an example, “today's closing price is lower than the previous day's closing price”.

First, the generating unit 141 automatically breaks down the preset rule by syntactic analysis, and thereby generates a derived rule (step S11). For example, the generating unit 141 breaks down into a plurality of conditions included in the preset rule. Then, the generating unit 141 generates a derived rule where one of the plurality of broken-down conditions is negated. As an example, the generating unit 141 generates “(other than condition A) and condition B and condition C”, as a derived rule.

Thereafter, the extracting unit 142 receives data through the communication control I/F unit 11 (step S12). Then, the extracting unit 142 determines whether all of the conditions of the preset rule hold (step S13). If it is determined that all of the conditions of the preset rule hold (step S13; Yes), the reporting unit 143 transmits a recommendation (report content) associated with the rule, to the report destination server apparatus 2 (step S14). As an example, the reporting unit 143 transmits the recommendation “the conditions are met by condition A and condition B and condition C”. Then, to receive the next data, the data extraction process transitions to step S12.

On the other hand, if it is determined that not all of the conditions of the preset rule hold (step S13; No), the extracting unit 142 determines whether there is only one condition left in the rule to hold all of the conditions (step S15). For example, the extracting unit 142 determines whether all of the conditions of the derived rule generated by the generating unit 141 hold.

If it is determined that there is only one condition left to hold all of the conditions (step S15; Yes), the reporting unit 143 transmits a recommendation (report content) associated with the derived rule, to the report destination server apparatus 2 (step S16). As an example, the reporting unit 143 transmits the recommendation “all of the conditions are met only if condition C holds true”. Then, the data extraction process transitions to step S17.

On the other hand, if it is determined that there is not only one condition left to hold all of the conditions (step S15; No), the extracting unit 142 moves to step S17.

At step S17, the optimizing unit 144 determines whether the optimization condition holds (step S17). For example, the optimizing unit 144 determines whether the received data matches the optimization condition stored in the optimization condition table 132. If it is determined that the optimization condition does not hold (step S17; No), to receive the next data, the data extraction process transitions to step S12.

On the other hand, if it is determined that the optimization condition holds (step S17; Yes), the optimizing unit 144 optimizes the derived rule by the optimization condition (step S18). As an example, if the today's closing price (A′) is lower than the previous day's closing price, then the optimizing unit 144 determines that the optimization condition holds. Then, the optimizing unit 144 optimizes the derived rule by the condition value A′ of the optimization condition. Specifically, the derived rule is optimized to “(condition A or more and condition A′ or less) and condition B and condition C”. Then, to receive the next data, the data extraction process transitions to step S12.

### Advantageous Effect of the First Embodiment

According to the first embodiment, the server apparatus 1 performs data extraction according to a preset rule, and also performs data extraction according to a plurality of derived rules, each of which is automatically generated by changing a condition of the preset rule. Then, when data extraction by the preset rule fails, if the plurality of derived rules include a derived rule by which data extraction is succeeded, then the server apparatus 1 reports the presence of the derived rule. According to such a configuration, even if the server apparatus 1 fails in data extraction by a preset rule, the server apparatus 1 can reveal the presence of a derived rule which is automatically generated from the set rule. Thus, the derived rule can be used to review the preset rule.

### [b] Second Embodiment

Meanwhile, the first embodiment describes the case in which a server apparatus 1 automatically generates derived rules where a condition of a set rule is changed, and even if data extraction by the set rule fails, if there is a derived rule by which data extraction is succeeded, then the presence of the derived rule is reported. However, the server apparatus 1 is not limited thereto. The server apparatus 1 may preset a success condition as to whether to validate a derived rule, and when there is a derived rule that matches the set success condition, the server apparatus 1 may add the rule as a valid rule.

Hence, a second embodiment describes the case in which the server apparatus 1 further presets a success condition as to whether to validate a derived rule, and when there is a derived rule that matches the set success condition, the server apparatus 1 adds the rule as a valid rule. The valid rule as used herein refers to, for example, a normal rule that makes a recommendation indicating it is the timing of stock trading.

Configuration of a CEP System According to the Second Embodiment

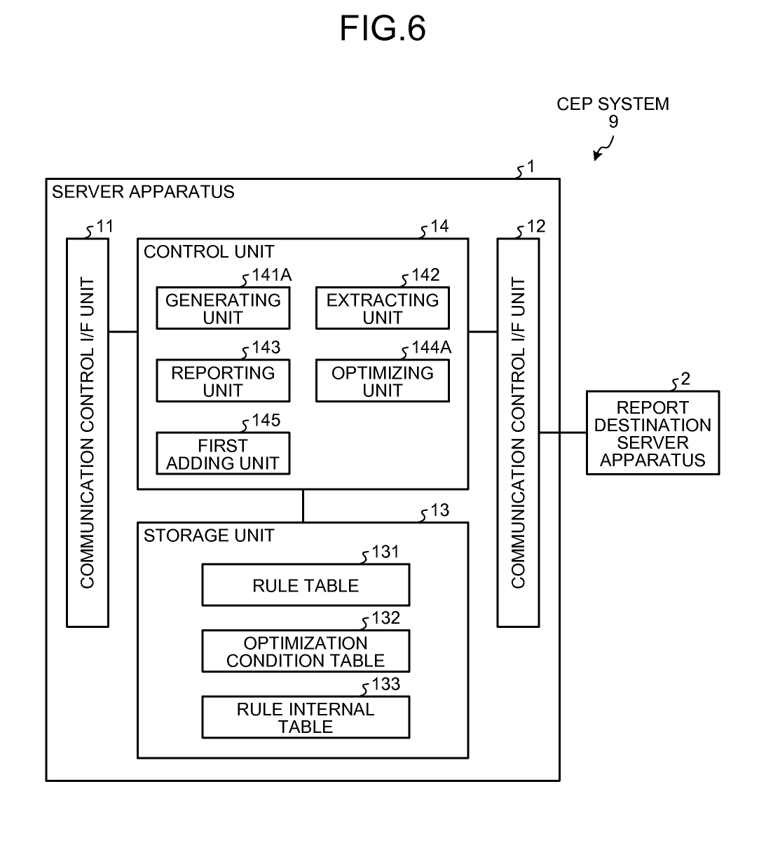

FIG. 6 is a diagram illustrating an overall configuration of a CEP system including a server apparatus, according to the second embodiment. Note that by denoting the same configurations as those of a CEP system 9 illustrated in FIG. 1 by the same reference signs, description of the overlapping configurations and operation is omitted. The difference between the first embodiment and the second embodiment is that a first adding unit 145 is added to a control unit 14. The difference between the first embodiment and the second embodiment is that a generating unit 141 and an optimizing unit 144 are changed to a generating unit 141A and an optimizing unit 144A, respectively. In addition, the difference between the first embodiment and the second embodiment is that a rule internal table 133 is added to a storage unit 13.

The generating unit 141A generates derived rules where a condition of a preset rule is changed. For example, the generating unit 141A performs syntactic analysis on a preset rule to break down into a plurality of conditions included in the rule. Then, the generating unit 141A generates a derived rule where one of the plurality of broken-down conditions is negated. Then, the generating unit 141A stores the generated derived rule in a rule table 131. At this time, the generating unit 141A stores report content which is reported to the user when the derived rule is matched, together with the generated derived rule, in the rule table 131.

In addition, the generating unit 141A stores the generated derived rules in the rule internal table 133.

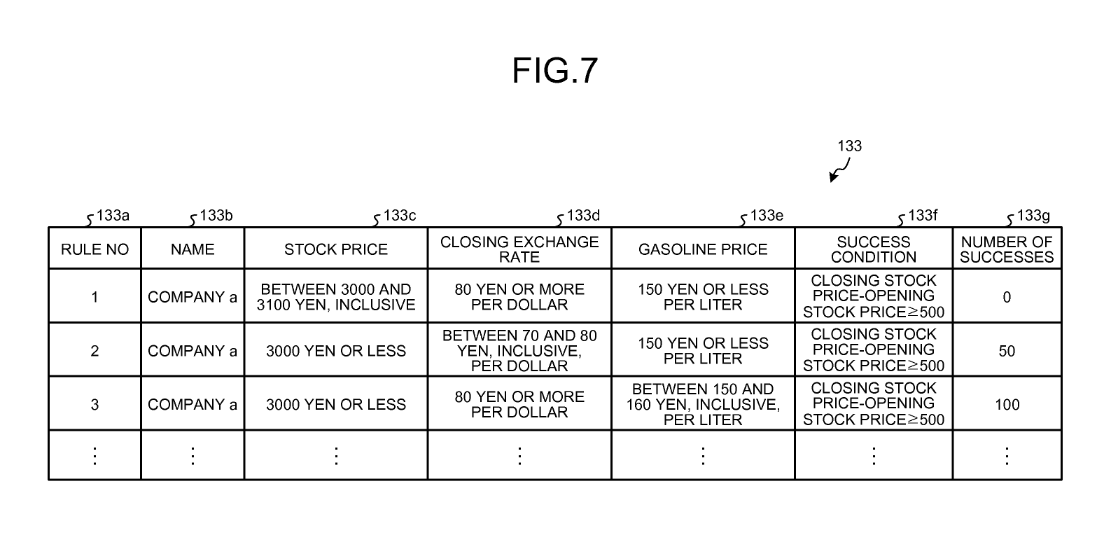

The rule internal table 133 is a table that stores the derived rules, each of which is automatically generated by changing a condition of the preset rule. The rule internal table 133 further prestores a success condition as to whether to validate a derived rule as a rule. Now, the data structure of the rule internal table 133 will be described with reference to FIG. 7. FIG. 7 is a diagram illustrating an example of the data structure of the rule internal table.

As illustrated in FIG. 7, the rule internal table 133 stores a rule No 133a, a name 133b, a stock price 133c, a closing exchange rate 133d, a gasoline price 133e, a success condition 133f, and the number of successes 133g in association with one another. The rule No 133a is an identification number that uniquely identifies a rule. The name 133b indicates a name to which the rule is applied. The stock price 133c is a condition related to a stock price. The closing exchange rate 133d is a condition related to a closing exchange rate. The gasoline price 133e is a condition related to a gasoline price. The success condition 133f is a success condition as to whether to validate the rule indicated by the rule No 133a as a rule. The number of successes 133g is the number of times a condition including the success condition has succeeded. When the number of times indicated by the number of successes 133g is greater than or equal to a predetermined threshold value (hereinafter, referred to as the “threshold value of the number of successes”), the first adding unit 145 which will be described later validates the rule indicated by the rule No 133a as a rule. Note that the success condition 133f and the number of successes 133g are, for example, preset by the user. The rule No 133a, the name 133b, the stock price 133c, the closing exchange rate 133d, and the gasoline price 133e are stored by the generating unit 141A.

As an example, when the rule No 133a is “1”, “company a” is stored as the name 133b, “between 3000 and 3100 yen, inclusive” is stored as the stock price 133c, and “80 yen or more per dollar” is stored as the closing exchange rate 133d. As the gasoline price 133e, “150 yen or less per liter” is stored, and as the success condition 133f, “closing stock price−opening stock price≧500” is stored, and as the number of successes 133g, “0” is stored.

Referring back to FIG. 6, when the plurality of derived rules include a derived rule that satisfies the preset success condition, the first adding unit 145 adds the derived rule to the normal rules. For example, the first adding unit 145 filters (extracts), for each derived rule stored in the rule internal table 133, a plurality of types of received data, based on a plurality of conditions included in the derived rule. The first adding unit 145 extracts each of data that matches all conditions. In addition, the first adding unit 145 determines whether a success condition 133f of a derived rule whose conditions are all matched is satisfied. When the first adding unit 145 determines that the success condition 133f is satisfied, the first adding unit 145 adds one to the number of successes 133g. Then, the first adding unit 145 determines whether the number of successes 133g is greater than or equal to the threshold value of the number of successes. When the number of successes 133g is greater than or equal to the threshold value of the number of successes, the first adding unit 145 adds the corresponding derived rule to the rule table 131. Namely, when the number of successes for the success condition has reached the preset threshold value, the first adding unit 145 adds the corresponding derived rule as a valid rule. At this time, the first adding unit 145 sets the content of a recommendation associated with the success condition, in report content 131f in the rule table 131. As an example, the content of a recommendation associated with the success condition is content indicating the “buy” timing of stock trading.

The optimizing unit 144A optimizes the derived rule.

As an example, when received data matches an optimization condition stored in an optimization condition table 132, the optimizing unit 144A updates a corresponding condition in the rule table 131 in the direction of change corresponding to the optimization condition. In addition, when the received data matches the optimization condition stored in the optimization condition table 132, the optimizing unit 144A updates a corresponding condition in the rule internal table 133 in the direction of change corresponding to the optimization condition.

As another example, when a derived rule is added to the normal rules by the first adding unit 145, if received data matches the optimization condition stored in the optimization condition table 132, then the optimizing unit 144A performs the following processes. Specifically, the optimizing unit 144A changes a corresponding condition of the added derived rule in the direction of change corresponding to the optimization condition. Then, the optimizing unit 144A generates a new derived rule including the changed condition, from the added derived rule. Then, the optimizing unit 144A adds the generated derived rule to the rule internal table 133.

Example of a Specific Process Performed by the CEP System

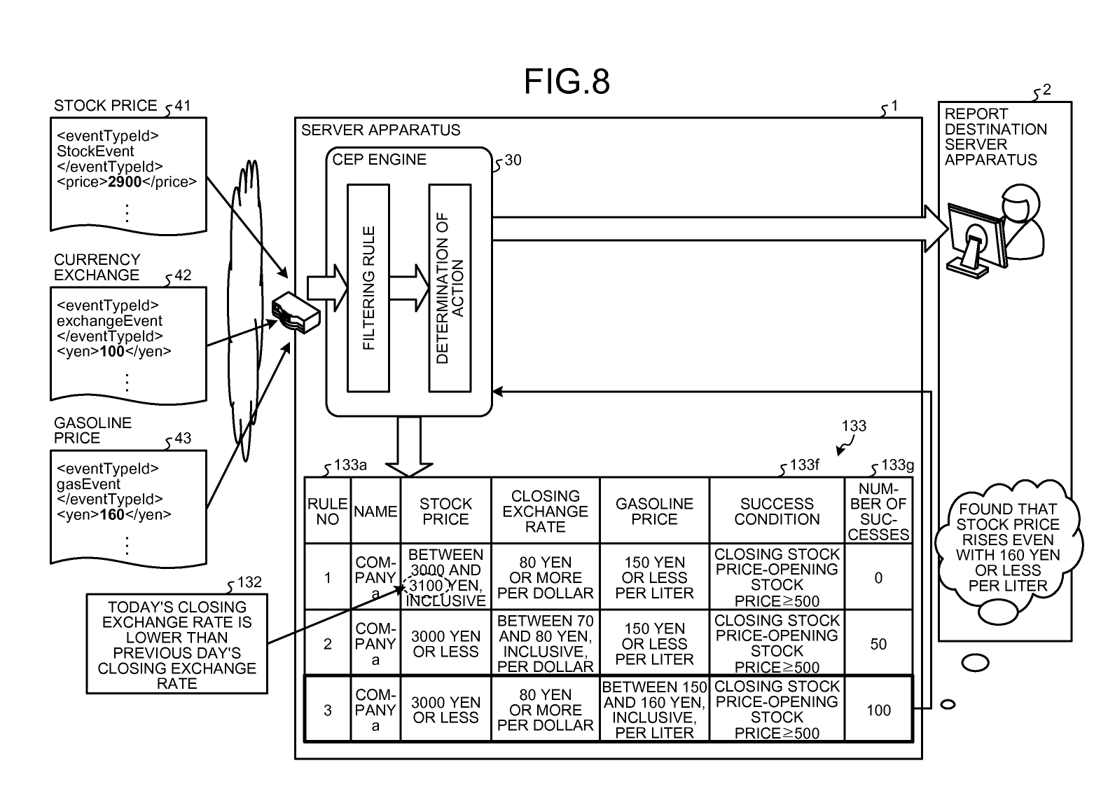

FIG. 8 is a diagram illustrating an example of a specific process performed by the CEP system according to the second embodiment. As illustrated in FIG. 8, stock price information 41, currency exchange information 42, and gasoline price information 43 are distributed as needed to the server apparatus 1 from a server of a dealer that provides a service to provide information including stock prices, currency exchange, and gasoline prices. In the example of FIG. 8, the stock price information 41, the currency exchange information 42, and the gasoline price information 43 have a data structure in XML (Extensible Markup Language) format. The stock price information 41 in the example of FIG. 8 indicates that the stock price is 2900 [yen]. The currency exchange information 42 in the example of FIG. 8 indicates that it is 100 [yen]. The gasoline price information 43 in the example of FIG. 8 indicates that it is 160 [yen].

In the server apparatus 1, a CEP engine 30 operates. The CEP engine 30 is included in the control unit 14, and is software that implements complex event processing. The software that implements complex event processing includes, for example, Esper.

It is assumed that, as a rule preset by the user, “the stock price of company a is 3000 yen or less, and the closing exchange rate is 80 yen or more per dollar, and the gasoline price is 150 yen or less per liter” is set on the server apparatus 1. Derived rules which are generated from the rule preset by the user are stored in the rule internal table 133. For example, as a derived rule with rule No 133a “1”, “(the stock price of company a is between 3000 and 3100 yen, inclusive) and (the closing exchange rate is 80 yen or more per dollar) and (the gasoline price is 150 yen or less per liter)” is set. As a derived rule with rule No 133a “2”, “(the stock price of company a is 3000 yen or less) and (the closing exchange rate is between 70 and 80 yen, inclusive, per dollar) and (the gasoline price is 150 yen or less per liter)” is set. As a derived rule with rule No 133a “3”, “(the stock price of company a is 3000 yen or less) and (the closing exchange rate is 80 yen or more per dollar) and (the gasoline price is between 150 and 160 yen, inclusive, per liter)” is set. Each of the derived rules is set with “closing stock price−opening stock price≧500” as a success condition 133f.

Here, it is assumed that, as an optimization condition, “today's closing exchange rate is lower than the previous day's closing exchange rate” is stored in the optimization condition table 132. In addition, it is assumed that it is the case in which the received data matches the optimization condition set in the optimization condition table 132. Then, the CEP engine 30 updates a corresponding condition value in the direction of change corresponding to the optimization condition. In the example of FIG. 8, the stock price of the derived rule with rule No 133a “1” is updated to “between 3000 and 3100 yen, inclusive”.

Then, the CEP engine 30 filters (extracts), for each derived rule stored in the rule internal table 133, data using a plurality of conditions included in the derived rule. The CEP engine 30 extracts each of data that matches all conditions. Then, the CEP engine 30 determines whether the success condition 133f of a derived rule whose conditions are all matched is satisfied. When the CEP engine 30 determines that the success condition 133f is satisfied, the CEP engine 30 adds one to the number of successes 133g. Then, the CEP engine 30 determines whether the number of successes 133g is greater than or equal to the threshold value of the number of successes. When the number of successes 133g is greater than or equal to the threshold value of the number of successes, the CEP engine 30 adds the corresponding derived rule to the rule table 131.

In the example of FIG. 8, it is assumed that the threshold value of the number of successes is 100. Then, since the number of successes of the derived rule with rule No 133a “3” has reached 100, the CEP engine 30 adds the derived rule to the rule table 131. The CEP engine 30 adds the derived rule with rule No 133a “3” to the rule table 131, as a valid rule. At this time, the CEP engine 30 sets a recommendation associated with the success condition, e.g., “buy”, in report content 131f in the rule table 131.

Then, when stock price information 41, currency exchange information 42, and gasoline price information 43 to be received match all of a plurality of conditions of any of the rules set in the rule table 131, the CEP engine 30 recommends content associated with the matched rule to a report destination server apparatus 2. For example, when a plurality of conditions of the rule with rule No 133a “3” are all matched, the CEP engine 30 recommends “buying conditions for company a are met. The current stock price is 2900 yen, currency exchange is 100 yen, and gasoline price is 160 yen.” to the report destination server apparatus 2.

By this, the server apparatus 1 can automatically add, as a valid rule, the derived rule whose success condition is matched, to the rule table 131. When, thereafter, a plurality of conditions of the rule are all matched, the server apparatus 1 can reveal the presence of the rule. As a result, in the report destination server apparatus 2, the user can be prevented from missing a stock trading opportunity. In addition, the user can review the current rule.

Another Example of a Specific Process Performed by the CEP System

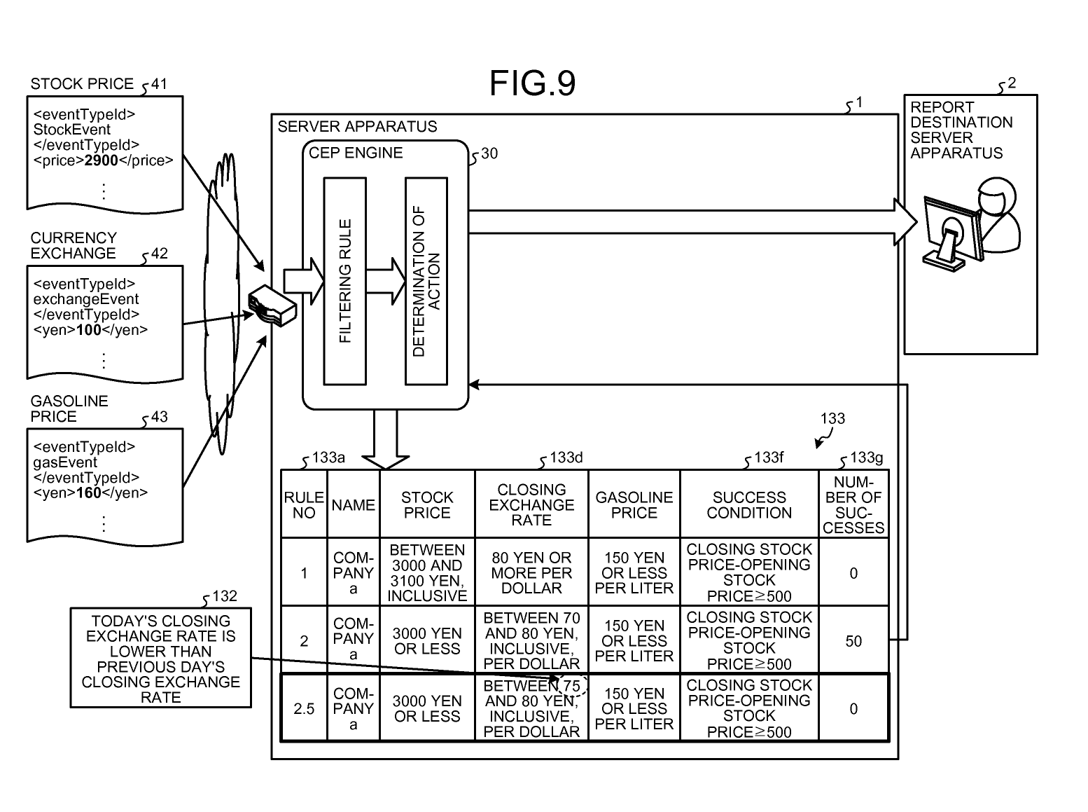

FIG. 9 is a diagram illustrating another example of a specific process performed by the CEP system according to the second embodiment. As illustrated in FIG. 9, as in FIG. 8, stock price information 41, currency exchange information 42, and gasoline price information 43 are distributed as needed to the server apparatus 1.

In the server apparatus 1, derived rules which are generated from a rule preset by the user are stored in the rule internal table 133. Of the derived rules in the rule internal table 133 illustrated in FIG. 9, derived rules with rule Nos 133a “1” and “2” are set. Each of the derived rules is set with “closing stock price−opening stock price≧500” as a success condition 133f. In addition, it is assumed that, as an optimization condition, “today's closing exchange rate is lower than the previous day's closing exchange rate” is stored in the optimization condition table 132.

Under such an environment, the CEP engine 30 filters (extracts), for each derived rule stored in the rule internal table 133, data using a plurality of conditions included in the derived rule. The CEP engine 30 extracts each of data that matches all conditions. Then, the CEP engine 30 determines whether the success condition 133f of a derived rule whose conditions are all matched is satisfied. When the CEP engine 30 determines that the success condition 133f is satisfied, the CEP engine 30 adds one to the number of successes 133g. Then, the CEP engine 30 determines whether the number of successes 133g is greater than or equal to the threshold value of the number of successes. When the number of successes 133g is greater than or equal to the threshold value of the number of successes, the CEP engine 30 adds the corresponding derived rule to the rule table 131.

In the example of FIG. 9, it is assumed that the threshold value of the number of successes is 50. Then, since the number of successes of the derived rule with rule No 133a “2” has reached 50, the CEP engine 30 adds the derived rule to the rule table 131. The CEP engine 30 adds the derived rule with rule No 133a “2” to the rule table 131, as a valid rule.

Furthermore, when the received data matches the optimization condition stored in the optimization condition table 132, the CEP engine 30 changes a corresponding condition of the added derived rule in the direction of change corresponding to the optimization condition. Then, the CEP engine 30 generates a new derived rule including the changed condition, from the added derived rule and adds the new derived rule to the rule internal table 133.

In the example of FIG. 9, the case is assumed in which the CEP engine 30 determines that the received data matches the optimization condition “today's closing exchange rate is lower than the previous day's closing exchange rate” which is set in the optimization condition table 132. Then, the CEP engine 30 changes, for example, the condition of the closing exchange rate 133d of the added derived rule with rule No 133a “2” from “between 70 and 80 yen, inclusive, per dollar” to “between 75 and 80 yen, inclusive, per dollar”. Then, the CEP engine 30 generates a new derived rule including the changed condition of the closing exchange rate, from the added derived rule with rule No 133a “2”, and adds the new derived rule to the rule internal table 133. Specifically, a derived rule with rule No 133a “2.5” is newly added.

By this, when the optimization condition is matched, the server apparatus 1 generates a new derived rule where a corresponding condition of the derived rule is changed in the direction of change corresponding to the optimization condition. Thus, the server apparatus 1 can dynamically add the derived rule, according to a changing environment.

Procedure of a Data Extraction Process

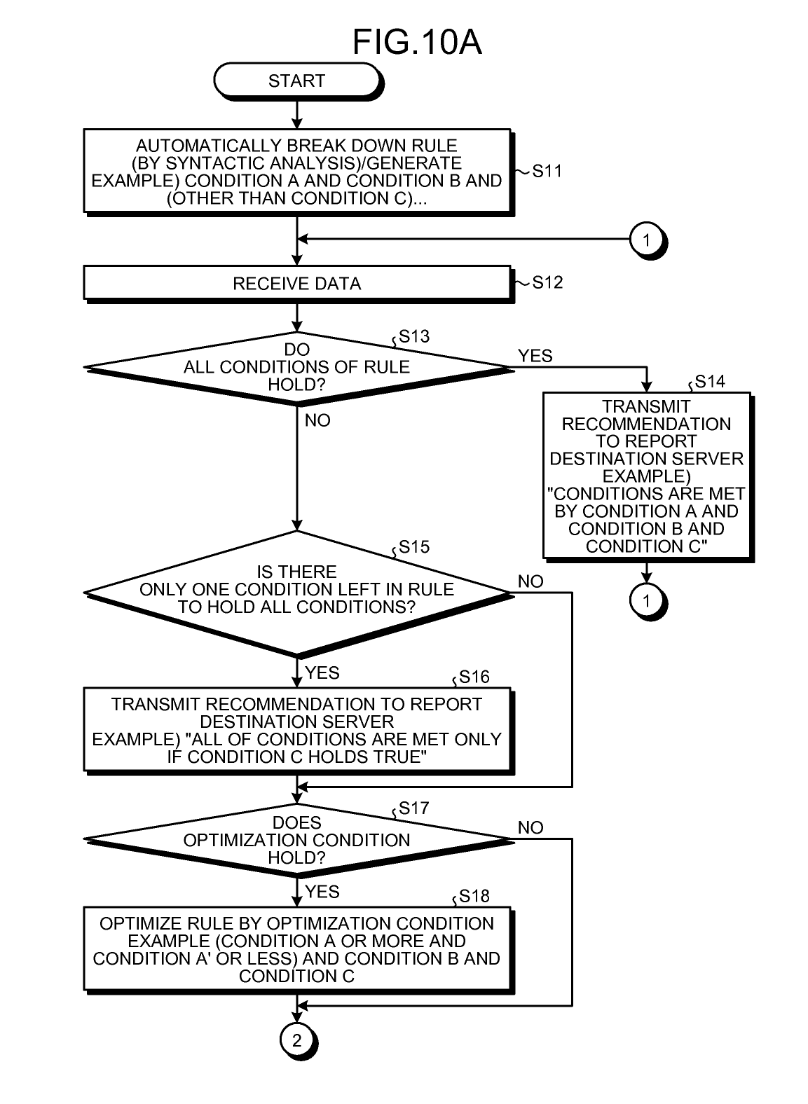

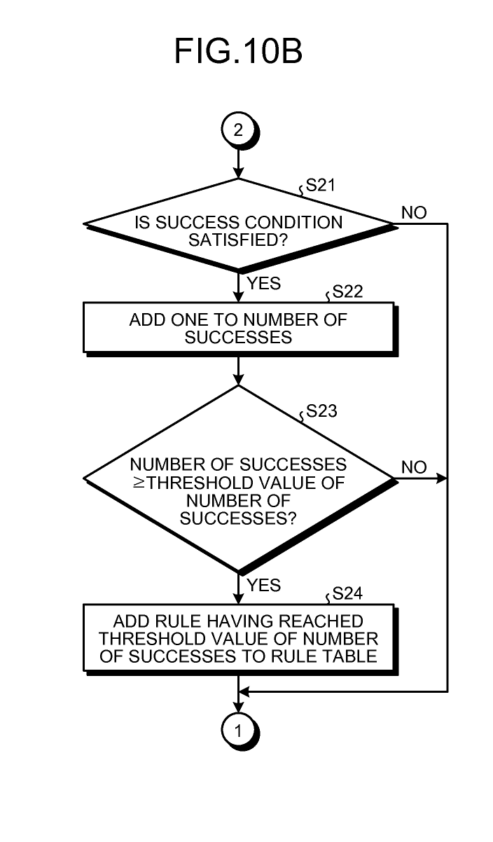

Next, with reference to FIGS. 10A and 10B, the procedure of a data extraction process will be described. FIGS. 10A and 10B are flowcharts illustrating the procedure of a data extraction process according to the second embodiment. Note that S11 to S18 are the same processes as those of a data extraction process according to the first embodiment, and thus, description of the processes is simplified.

First, the generating unit 141A automatically breaks down a preset rule by syntactic analysis, and thereby generates a derived rule (step S11). Thereafter, an extracting unit 142 receives data through a communication control I/F unit 11 (step S12). Then, the extracting unit 142 determines whether all of the conditions of the preset rule hold (step S13).

If it is determined that all of the conditions of the preset rule hold (step S13; Yes), a reporting unit 143 transmits a recommendation (report content) associated with the rule, to the report destination server apparatus 2 (step S14). Then, to receive the next data, the data extraction process transitions to step S12.

On the other hand, if it is determined that not all of the conditions of the preset rule hold (step S13; No), the extracting unit 142 determines whether there is only one condition left in the rule to hold all of the conditions (step S15). For example, the extracting unit 142 determines whether all of the conditions of the derived rule generated by the generating unit 141A hold.

If it is determined that there is only one condition left to hold all of the conditions (step S15; Yes), the reporting unit 143 transmits a recommendation (report content) associated with the derived rule, to the report destination server apparatus 2 (step S16). On the other hand, if it is determined that there is not only one condition left to hold all of the conditions (step S15; No), the extracting unit 142 moves to step S17.

At step S17, the optimizing unit 144A determines whether the optimization condition holds (step S17). If it is determined that the optimization condition does not hold (step S17; No), the data extraction process transitions to step S21. On the other hand, if it is determined that the optimization condition holds (step S17; Yes), the optimizing unit 144A optimizes the derived rule by the optimization condition (step S18).

Subsequently, the first adding unit 145 determines whether the success condition 133f of the derived rule is satisfied (step S21). For example, the first adding unit 145 determines whether the success condition 133f of a derived rule whose conditions are all matched among the derived rules stored in the rule internal table 133 is satisfied.

If it is determined that the success condition 133f of the derived rule whose conditions are all matched is not satisfied (step S21; No), to receive the next data, the data extraction process transitions to step S12. On the other hand, if it is determined that the success condition 133f of the derived rule whose conditions are all matched is satisfied (step S21; Yes), the first adding unit 145 adds one to the number of successes 133g (step S22).

Then, the first adding unit 145 determines whether the number of successes 133g is greater than or equal to the threshold value of the number of successes (step S23). If it is determined that the number of successes 133g is not greater than or equal to the threshold value of the number of successes (step S23; No), to receive the next data, the data extraction process transitions to step S12.

On the other hand, if it is determined that the number of successes 133g is greater than or equal to the threshold value of the number of successes (step S23; Yes), the first adding unit 145 adds the derived rule having reached the threshold value of the number of successes, to the rule table 131 (step S24). Namely, when the number of successes for the success condition has reached the preset threshold value, the first adding unit 145 adds the corresponding derived rule to the rule table 131, as a valid rule. Then, to receive the next data, the data extraction process transitions to step S12.

### Advantageous Effect of the Second Embodiment

According to the second embodiment, the server apparatus 1 performs data extraction according to a preset rule, and also performs data extraction according to a plurality of derived rules, each of which is automatically generated by changing a condition of the preset rule. Then, when the plurality of derived rules include a derived rule that matches a preset success condition, the server apparatus 1 adds the derived rule to the rule table 131, as a normal rule. According to such a configuration, the server apparatus 1 can dynamically add a derived rule that matches the preset success condition, to the rule table 131, according to a changing environment.

In addition, according to the second embodiment, when a plurality of derived rules include a derived rule that matches the success condition, the server apparatus 1 reports the presence of the derived rule. According to such a configuration, the server apparatus 1 can reveal the presence of the derived rule that matches the success condition. As a result, the report destination can be prevented from missing a stock trading opportunity and can review the current rule.

### [c] Third Embodiment

Meanwhile, the first embodiment describes the case in which a server apparatus 1 automatically generates derived rules where a condition of a set rule is changed, and even if data extraction by the set rule fails, if there is a derived rule by which data extraction is succeeded, then the presence of the derived rule is reported. The second embodiment describes the case in which, when a plurality of derived rules include a derived rule that matches a preset success condition, the server apparatus 1 further adds the derived rule to a rule table 131, as a normal rule. However, the server apparatus 1 is not limited thereto. When there is a derived rule that matches a condition negating a success condition, the server apparatus 1 may further add the rule as a valid rule.

Hence, a third embodiment describes the case in which, when there is a derived rule that matches a condition negating a success condition, the server apparatus 1 further adds the rule as a valid rule. The valid rule as used herein refers to, for example, a normal rule that makes a recommendation indicating it is the timing of stock trading.

Configuration of a CEP System According to the Third Embodiment

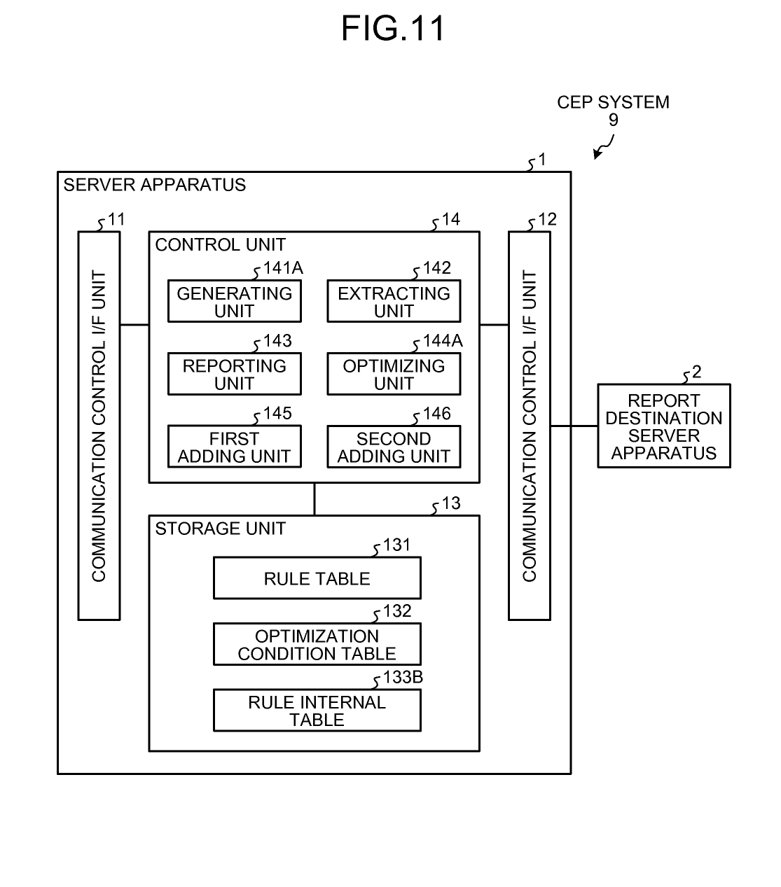

FIG. 11 is a diagram illustrating an overall configuration of a CEP system including a server apparatus, according to the third embodiment. Note that by denoting the same configurations as those of CEP systems 9 illustrated in FIGS. 1 and 6 by the same reference signs, description of the overlapping configurations and operation is omitted. The difference between the first and second embodiments and the third embodiment is that a second adding unit 146 is added to a control unit 14. The difference between the first and second embodiments and the third embodiment is that a rule internal table 133 is changed to a rule internal table 133B.

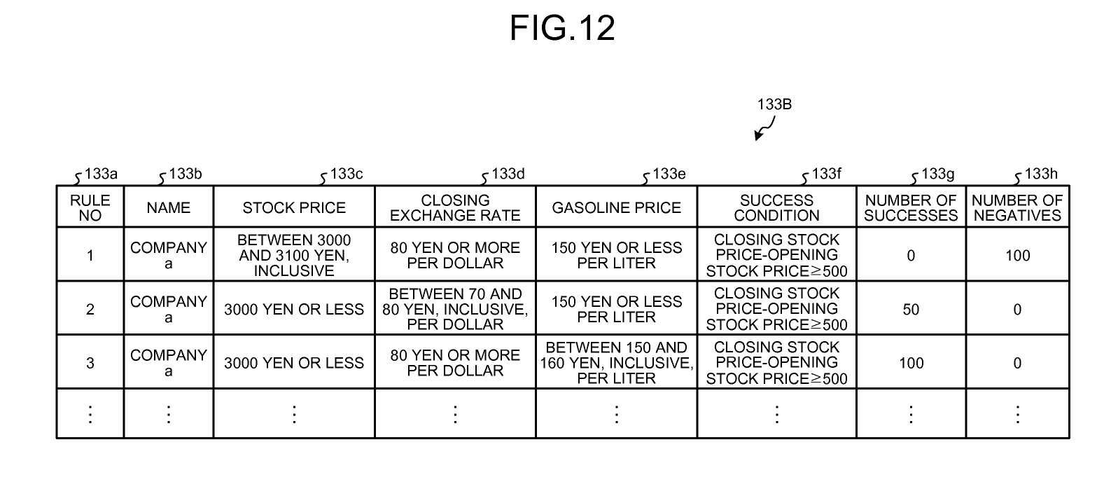

By denoting the same data structures of a rule internal table 133 illustrated in FIG. 7 and a rule internal table 133B illustrated in FIG. 12 by the same reference signs, description of the overlapping structures is omitted. The difference between the rule internal table 133 illustrated in FIG. 7 and the rule internal table 133B illustrated in FIG. 12 is that the number of negatives 133h is added. The number of negatives 133h is the number of times the result of a success condition has become negative. Namely, the number of negatives 133h is the number of times a condition negating the success condition has succeeded. When the number of times indicated by the number of negatives 133h is greater than or equal to a predetermined threshold value (hereinafter, referred to as the “threshold value of the number of negatives”), the second adding unit 146 which will be described later validates the rule indicated by rule No 133a as a rule. Note that the number of negatives 133h is, for example, preset by the user.

As an example, when the rule No 133a is “1”, “company a” is stored as a name 133b, “between 3000 and 3100 yen, inclusive” is stored as a stock price 133c, and “80 yen or more per dollar” is stored as a closing exchange rate 133d. As a gasoline price 133e, “150 yen or less per liter” is stored, and as a success condition 133f, “closing stock price−opening stock price≧500” is stored, and as the number of successes 133g, “0” is stored, and as the number of negatives 133h, “100” is stored.

Referring back to FIG. 11, when a plurality of derived rules include a derived rule that satisfies a condition negating a preset success condition, the second adding unit 146 adds the derived rule to the normal rules. For example, the second adding unit 146 filters (extracts), for each derived rule stored in the rule internal table 133B, a plurality of types of received data, based on a plurality of conditions included in the derived rule. The second adding unit 146 extracts each of data that matches all conditions. In addition, the second adding unit 146 determines whether a success condition 133f of a derived rule whose conditions are all matched is satisfied. Here, when the second adding unit 146 determines that the success condition 133f is not satisfied, the second adding unit 146 adds one to the number of negatives 133h. Namely, the second adding unit 146 determines that the result of the success condition 133f is negative, and thus, the second adding unit 146 adds one to the number of negatives 133h. Then, the second adding unit 146 determines whether the number of negatives 133h is greater than or equal to the threshold value of the number of negatives. When the number of negatives 133h is greater than or equal to the threshold value of the number of negatives, the second adding unit 146 adds the corresponding derived rule to a rule table 131. Specifically, when the number of negatives for the condition negating the success condition has reached the preset threshold value, the second adding unit 146 adds the corresponding derived rule as a valid rule. At this time, the second adding unit 146 sets the content of a recommendation associated with the condition negating the success condition, in report content 131f in the rule table 131. As an example, when the content of a recommendation associated with the success condition is content indicating “buy” timing, the content of a recommendation associated with the condition negating the success condition is content indicating “sell” timing.

Example of a Specific Process Performed by the CEP System

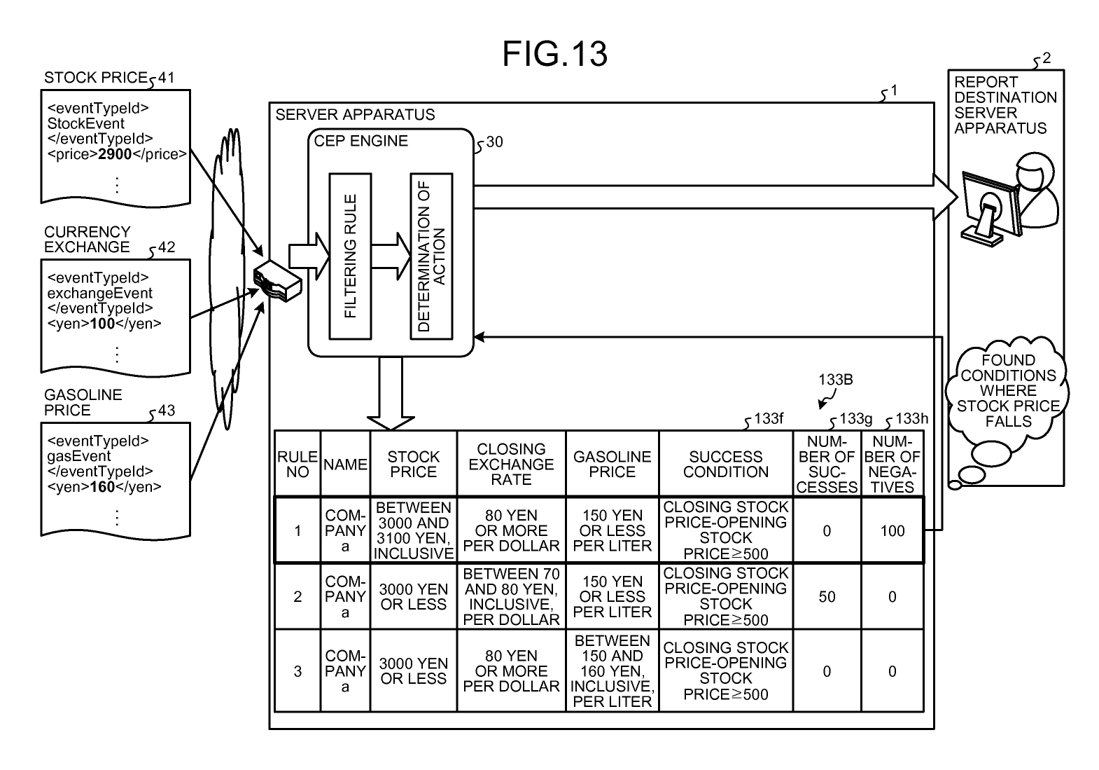

FIG. 13 is a diagram illustrating an example of a specific process performed by the CEP system according to the third embodiment. As illustrated in FIG. 13, stock price information 41, currency exchange information 42, and gasoline price information 43 are distributed as needed to the server apparatus 1 from a server of a dealer that provides a service to provide information including stock prices, currency exchange, and gasoline prices. In the example of FIG. 13, the stock price information 41, the currency exchange information 42, and the gasoline price information 43 have a data structure in XML (Extensible Markup Language) format. The stock price information 41 in the example of FIG. 13 indicates that the stock price is 2900 [yen]. The currency exchange information 42 in the example of FIG. 13 indicates that it is 100 [yen]. The gasoline price information 43 in the example of FIG. 13 indicates that it is 160 [yen].

In the server apparatus 1, a CEP engine 30 operates. The CEP engine 30 is included in the control unit 14, and is software that implements complex event processing. The software that implements complex event processing includes, for example, Esper.

It is assumed that, as a rule preset by the user, “the stock price of company a is 3000 yen or less, and the closing exchange rate is 80 yen or more per dollar, and the gasoline price is 150 yen or less per liter” is set on the server apparatus 1. Derived rules which are generated from the rule preset by the user are stored in the rule internal table 133B. For example, as a derived rule with rule No 133a “1”, “(the stock price of company a is between 3000 and 3100 yen, inclusive) and (the closing exchange rate is 80 yen or more per dollar) and (the gasoline price is 150 yen or less per liter)” is set. The derived rules are set with “closing stock price−opening stock price≧500” as a success condition 133f.

Then, the CEP engine 30 filters (extracts), for each derived rule stored in the rule internal table 133B, data using a plurality of conditions included in the derived rule. The CEP engine 30 extracts each of data that matches all conditions. Then, the CEP engine 30 determines whether the success condition 133f of a derived rule whose conditions are all matched is satisfied. When the CEP engine 30 determines that the success condition 133f is not satisfied, the CEP engine 30 adds one to the number of negatives 133h. Then, the CEP engine 30 determines whether the number of negatives 133h is greater than or equal to the threshold value of the number of negatives. When the number of negatives 133h is greater than or equal to the threshold value of the number of negatives, the CEP engine 30 adds the corresponding derived rule to the rule table 131.

In the example of FIG. 13, it is assumed that the threshold value of the number of negatives is 100. Then, since the number of negatives of the derived rule with rule No 133a “1” has reached 100, the CEP engine 30 adds the derived rule to the rule table 131. The CEP engine 30 adds the derived rule with rule No 133a “1” to the rule table 131, as a valid rule. At this time, the CEP engine 30 sets a recommendation associated with the condition negating the success condition, e.g., “sell”, in report content 131f in the rule table 131.

Then, when stock price information 41, currency exchange information 42, and gasoline price information 43 to be received match all of a plurality of conditions of any of the rules set in the rule table 131, the CEP engine 30 recommends content associated with the matched rule to a report destination server apparatus 2. For example, when a plurality of conditions of the rule with rule No 133a “1” are all matched, the CEP engine 30 recommends “selling conditions for company a are met. The current stock price is 2900 yen, currency exchange is 100 yen, and gasoline price is 160 yen.” to the report destination server apparatus 2.

By this, the server apparatus 1 can automatically add, as a valid rule, the derived rule that matches the condition negating the success condition 133f, to the rule table 131. When, thereafter, the plurality of conditions of the rule are all matched, the server apparatus 1 can reveal the presence of the rule. As a result, in the report destination server apparatus 2, the user can be prevented from missing a stock trading opportunity. In addition, the user can review the current rule.

Procedure of a Data Extraction Process

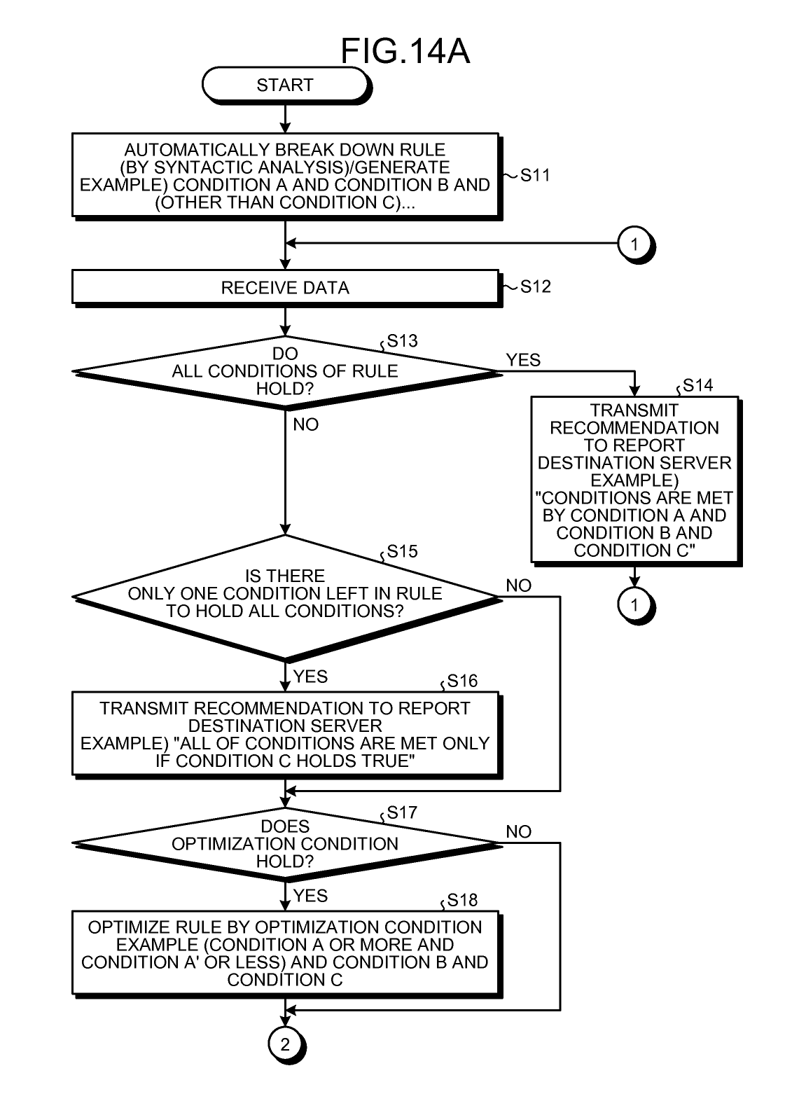

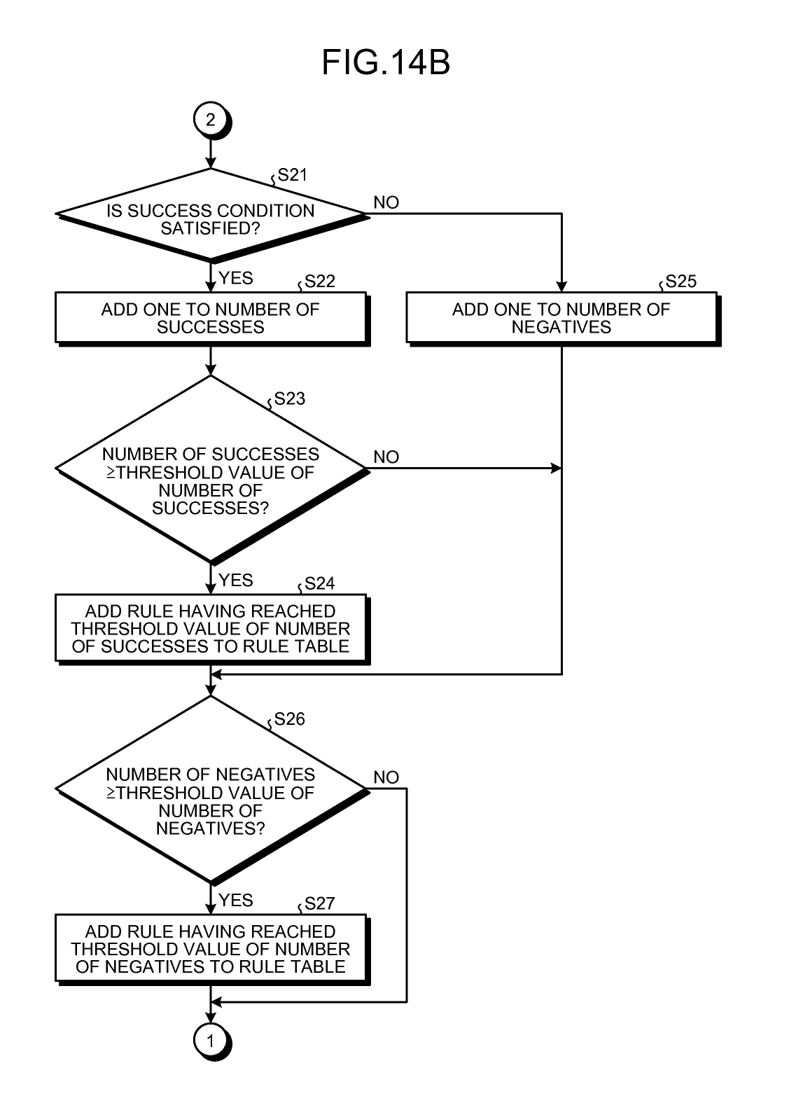

Next, with reference to FIGS. 14A and 14B, the procedure of a data extraction process will be described. FIGS. 14A and 14B are flowcharts illustrating the procedure of a data extraction process according to the third embodiment. Note that S11 to S18 are the same processes as those of a data extraction process according to the first embodiment, and thus, description of the processes is simplified.

First, a generating unit 141A automatically breaks down a preset rule by syntactic analysis, and thereby generates a derived rule (step S11). Thereafter, an extracting unit 142 receives data through a communication control I/F unit 11 (step S12). Then, the extracting unit 142 determines whether all of the conditions of the preset rule hold (step S13).

If it is determined that all of the conditions of the preset rule hold (step S13; Yes), a reporting unit 143 transmits a recommendation (report content) associated with the rule, to the report destination server apparatus 2 (step S14). Then, to receive the next data, the data extraction process transitions to step S12.

On the other hand, if it is determined that not all of the conditions of the preset rule hold (step S13; No), the extracting unit 142 determines whether there is only one condition left in the rule to hold all of the conditions (step S15). For example, the extracting unit 142 determines whether all of the conditions of the derived rule generated by the generating unit 141A hold.

If it is determined that there is only one condition left to hold all of the conditions (step S15; Yes), the reporting unit 143 transmits a recommendation (report content) associated with the derived rule, to the report destination server apparatus 2 (step S16). On the other hand, if it is determined that there is not only one condition left to hold all of the conditions (step S15; No), the extracting unit 142 moves to step S17.

At step S17, an optimizing unit 144A determines whether the optimization condition holds (step S17). If it is determined that the optimization condition does not hold (step S17; No), the data extraction process transitions to step S21. On the other hand, if it is determined that the optimization condition holds (step S17; Yes), the optimizing unit 144A optimizes the derived rule by the optimization condition (step S18).

Subsequently, a first adding unit 145 determines whether the success condition 133f of the derived rule is satisfied (step S21). For example, the first adding unit 145 determines whether the success condition 133f of a derived rule whose conditions are all matched among the derived rules stored in the rule internal table 133B is satisfied.

If it is determined that the success condition 133f of the derived rule whose conditions are all matched is satisfied (step S21; Yes), the first adding unit 145 adds one to the number of successes 133g (step S22). Then, the first adding unit 145 determines whether the number of successes 133g is greater than or equal to the threshold value of the number of successes (step S23). If it is determined that the number of successes 133g is not greater than or equal to the threshold value of the number of successes (step S23; No), the first adding unit 145 transitions to step S26.

On the other hand, if it is determined that the number of successes 133g is greater than or equal to the threshold value of the number of successes (step S23; Yes), the first adding unit 145 adds the derived rule having reached the threshold value of the number of successes, to the rule table 131 (step S24). Namely, when the number of successes for the success condition has reached the preset threshold value, the first adding unit 145 adds the corresponding derived rule to the rule table 131, as a valid rule. Then, the first adding unit 145 transitions to step S26.

At step S21, if it is determined that the success condition 133f of the derived rule whose conditions are all matched is not satisfied (step S21; No), the second adding unit 146 adds one to the number of negatives 133h (step S25). Then, the second adding unit 146 transitions to step S26.

At step S26, the second adding unit 146 determines whether the number of negatives 133h is greater than or equal to the threshold value of the number of negatives (step S26). If it is determined that the number of negatives 133h is not greater than or equal to the threshold value of the number of negatives (step S26; No), to receive the next data, the data extraction process transitions to step S12.

On the other hand, if it is determined that the number of negatives 133h is greater than or equal to the threshold value of the number of negatives (step S26; Yes), the second adding unit 146 adds the derived rule having reached the threshold value of the number of negatives, to the rule table 131 (step S27). Namely, when the number of times the result of the success condition has become negative has reached the preset threshold value, the second adding unit 146 adds the corresponding derived rule to the rule table 131, as a valid rule. Then, to receive the next data, the data extraction process transitions to step S12.

### Advantageous Effect of the Third Embodiment

According to the third embodiment, when a plurality of derived rules include a derived rule in which the number of times a condition negating a preset success condition is satisfied exceeds a threshold value, the server apparatus 1 adds the derived rule to the rule table 131, as a normal rule. According to such a configuration, the server apparatus 1 can dynamically add a derived rule that satisfies the condition negating the preset success condition, to the rule table 131, according to a changing environment.

### [d] Fourth Embodiment

Meanwhile, the first embodiment describes the case in which a server apparatus 1 automatically generates derived rules where a condition of a set rule is changed, and even if data extraction by the set rule fails, if there is a derived rule by which data extraction is succeeded, then the presence of the derived rule is reported. The second embodiment describes the case in which, when a plurality of derived rules include a derived rule that matches a preset success condition, the server apparatus 1 further adds the derived rule to a rule table 131, as a normal rule. The third embodiment describes the case in which, when a plurality of derived rules include a derived rule that matches a condition negating a preset success condition, the server apparatus 1 further adds the derived rule to the rule table 131, as a normal rule. However, the server apparatus 1 is not limited thereto. The server apparatus 1 may further derive a rule from a derived rule and detect the direction of an operational environment using the derived rule.

Hence, a fourth embodiment describes the case in which the server apparatus 1 further derives a rule from a derived rule and detects the direction of an operational environment using the derived rule. The direction of the operational environment as used herein refers to, for example, the direction of stock price or the direction of currency exchange in the case of using a CEP system for stock trading prediction.

Configuration of a CEP System According to the Fourth Embodiment

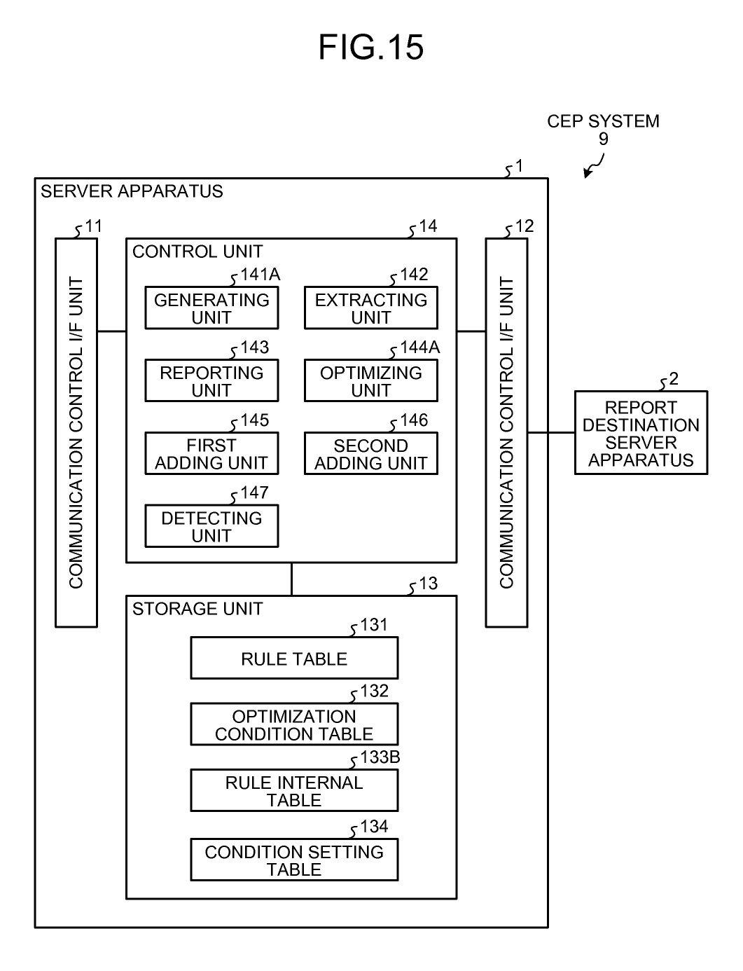

FIG. 15 is a diagram illustrating an overall configuration of a CEP system including a server apparatus, according to the fourth embodiment. Note that by denoting the same configurations as those of CEP systems 9 illustrated in FIGS. 1, 6, and 11 by the same reference signs, description of the overlapping configurations and operation is omitted. The difference between the first, second, and third embodiments and the fourth embodiment is that a detecting unit 147 is added to a control unit 14. In addition, the difference between the first, second, and third embodiments and the fourth embodiment is that a condition setting table 134 is added to a storage unit 13.

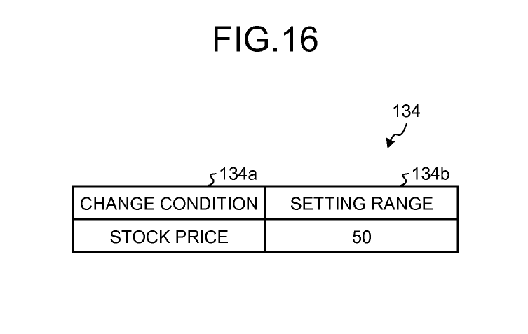

The condition setting table 134 is a table used to set a condition included in a derived rule. Now, the data structure of the condition setting table 134 will be described with reference to FIG. 16. FIG. 16 is a diagram illustrating an example of the data structure of the condition setting table. As illustrated in FIG. 16, the condition setting table 134 stores a change condition 134a and a setting range 134b in association with each other. The change condition 134a is an identifier of a condition to be changed in the rule. The setting range 134b indicates a setting range by which the condition value of the change condition 134a is changed. The change condition 134a and the setting range 134b are preset by the user. As an example, when the change condition 134a is “stock price”, “50” is stored as the setting range 134b.

Referring back to FIG. 15, when a derived rule which is automatically generated by changing a condition of a set rule is a derived rule whose specific condition value of a condition is to be changed, the detecting unit 147 generates derived rules that are derived from the derived rule, in the directions of change according to the change condition of the derived rule. For example, the detecting unit 147 extracts from a rule internal table 133B a derived rule whose specific condition value of a condition is to be changed. As an example, the rule internal table 133B may have a column item where a flag is set, and the detecting unit 147 may extract a derived rule whose flag is ON, as a derived rule whose specific condition value is to be changed. Then, for a condition indicated by the change condition 134a in the condition setting table 134 among the conditions included in the extracted derived rule, the detecting unit 147 calculates a new condition value which is increased by the amount corresponding to the setting range from the currently set condition value. Then, the detecting unit 147 generates a new derived rule where the calculated condition value is the upper limit of the change condition, from the extracted derived rule. In addition, for the condition indicated by the change condition 134a, the detecting unit 147 calculates a new condition value which is decreased by the amount corresponding to the setting range from the currently set condition value. Then, the detecting unit 147 generates a new derived rule where the calculated condition value is the lower limit of the change condition, from the extracted derived rule.

In addition, the detecting unit 147 adds the new generated derived rules to the rule internal table 133B. Note that the generation and addition of derived rules by the detecting unit 147 are performed, for example, before the operation of the system.

In addition, when the new generated derived rules include a derived rule that satisfies a success condition, the detecting unit 147 reports the content of the rule internal table 133B including the derived rule to a report destination server apparatus 2. For example, the detecting unit 147 filters (extracts), for each new derived rule stored in the rule internal table 133B, a plurality of types of received data, based on a plurality of conditions included in the derived rule. The detecting unit 147 extracts each of data that matches all conditions. In addition, the detecting unit 147 determines whether a success condition 133f of a derived rule whose conditions are all matched is satisfied. When the detecting unit 147 determines that the success condition 133f is satisfied, the detecting unit 147 adds one to the number of successes 133g. Then, the detecting unit 147 determines whether the number of successes 133g is greater than or equal to a threshold value of the number of successes. When the number of successes 133g is greater than or equal to the threshold value of the number of successes, the detecting unit 147 reports the content of the rule internal table 133B including the corresponding derived rule to the report destination server apparatus 2. Namely, at a point in time when the number of successes for the success condition has reached the preset threshold value, the detecting unit 147 reports the content of the rule internal table 133B to the report destination server apparatus 2.

Example of a Specific Process Performed by the CEP System

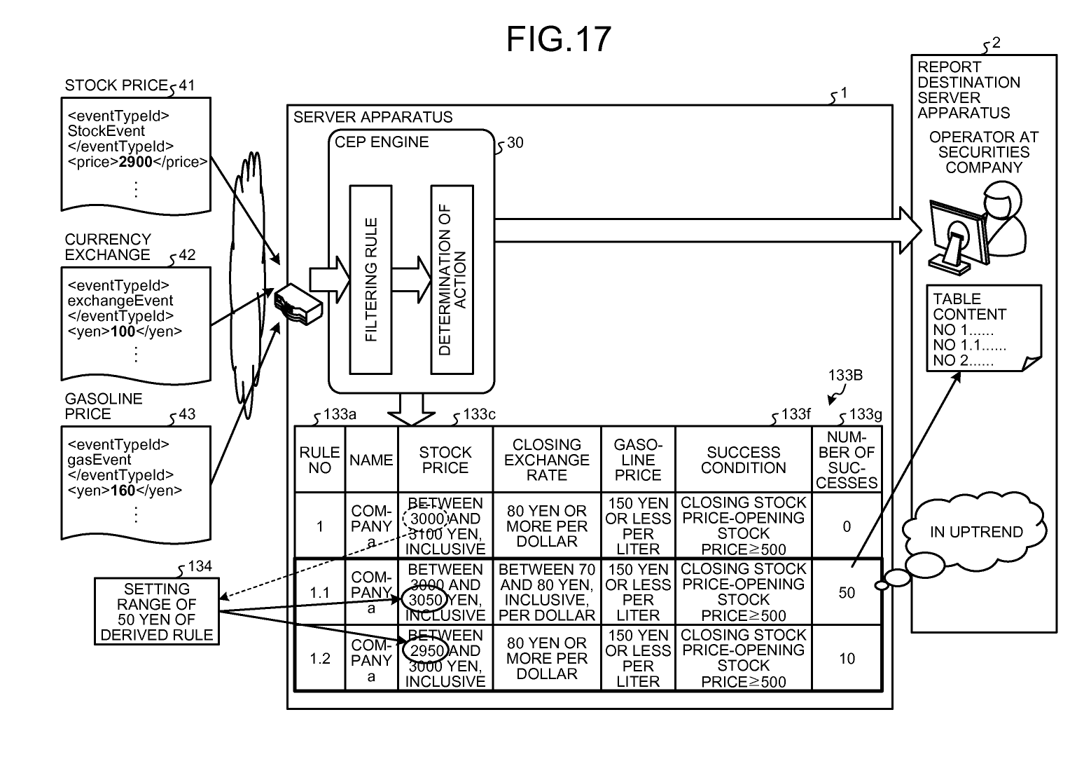

FIG. 17 is a diagram illustrating an example of a specific process performed by the CEP system according to the fourth embodiment. As illustrated in FIG. 17, stock price information 41, currency exchange information 42, and gasoline price information 43 are distributed as needed to the server apparatus 1 from a server of a dealer that provides a service to provide information including stock prices, currency exchange, and gasoline prices. In the example of FIG. 17, the stock price information 41, the currency exchange information 42, and the gasoline price information 43 have a data structure in XML (Extensible Markup Language) format. The stock price information 41 in the example of FIG. 17 indicates that the stock price is 2900 [yen]. The currency exchange information 42 in the example of FIG. 17 indicates that it is 100 [yen]. The gasoline price information 43 in the example of FIG. 17 indicates that it is 160 [yen].

In the server apparatus 1, a CEP engine 30 operates. The CEP engine 30 is included in the control unit 14, and is software that implements complex event processing. The software that implements complex event processing includes, for example, Esper.

It is assumed that, as a rule preset by the user, “the stock price of company a is 3000 yen or less, and the closing exchange rate is 80 yen or more per dollar, and the gasoline price is 150 yen or less per liter” is set on the server apparatus 1. Derived rules which are generated from the rule preset by the user are stored in the rule internal table 133B. For example, as a derived rule with rule No 133a “1”, “(the stock price of company a is between 3000 and 3100 yen, inclusive) and (the closing exchange rate is 80 yen or more per dollar) and (the gasoline price is 150 yen or less per liter)” is set. It is assumed that this derived rule is a derived rule whose specific condition value of a condition is to be changed. The derived rule is set with “closing stock price−opening stock price≧500” as a success condition 133f. In addition, in the condition setting table 134, “50” yen is stored as the setting range 134b when the change condition 134a is “stock price”.

Then, before the operation of the system, for the derived rule with rule No 133a “1” whose specific condition value of a condition is to be changed, the CEP engine 30 generates derived rules that are derived from the derived rule, in the directions of change according to the change condition of the derived rule. In the example of FIG. 17, for the condition value of the “stock price” indicated by the change condition 134a in the condition setting table 134 among the conditions included in the derived rule with rule No 133a “1”, the CEP engine 30 calculates new condition values.

As an example, the CEP engine 30 calculates a new condition value “3050” yen which is increased by the setting range 134b “50” yen from the condition value “3000” yen of the “stock price”. Then, the CEP engine 30 generates a new derived rule where the calculated condition value “3050” yen is the upper limit of the “stock price”. Specifically, a new derived rule with rule No 133a “1.1” where the condition of “stock price” is “(between 3000 and 3050 yen, inclusive)” is generated.

As another example, the CEP engine 30 calculates a new condition value “2950” yen which is decreased by the setting range 134b “50” yen from the condition value “3000” yen of the condition of “stock price”. Then, the CEP engine 30 generates a new derived rule where the calculated condition value “2950” yen is the lower limit of the “stock price”. Specifically, a new derived rule with rule No 133a “1.2” where the condition of “stock price” is “(between 2950 and 3000 yen, inclusive)” is generated.

Then, the CEP engine 30 adds the new derived rules to the rule internal table 133B. In FIG. 17, the new derived rules with rule Nos 133a “1.1” and “1.2” are added.

Then, the CEP engine 30 filters (extracts), for each new derived rule stored in the rule internal table 133B, data using a plurality of conditions included in the derived rule. The CEP engine 30 extracts each of data that matches all conditions. Then, the CEP engine 30 determines whether a success condition 133f of a derived rule whose conditions are all matched is satisfied. When the CEP engine 30 determines that the success condition 133f is satisfied, the CEP engine 30 adds one to the number of successes 133g. Then, the CEP engine 30 determines whether the number of successes 133g is greater than or equal to the threshold value of the number of successes. When the number of successes 133g is greater than or equal to the threshold value of the number of successes, the CEP engine 30 reports the content of the rule internal table 133B available at the present time to the report destination server apparatus 2.

In the example of FIG. 17, it is assumed that the threshold value of the number of successes is 50. Then, since the number of successes of the derived rule with rule No 133a “1.1” has reached 50, the CEP engine 30 reports the rule internal table 133B including the derived rule to the report destination server apparatus 2.

By this, the server apparatus 1 can detect the direction of the operational environment using the new derived rule that is derived from the derived rule. In the example of FIG. 17, since the number of successes of the derived rule where the condition of “stock price” is “between 3000 and 3050 yen, inclusive” has reached the threshold value, the server apparatus 1 can detect that the direction of stock price is in an uptrend. As a result, in the report destination server apparatus 2, the user can review the current rule from the direction of the operational environment.

Procedure of a Data Extraction Process

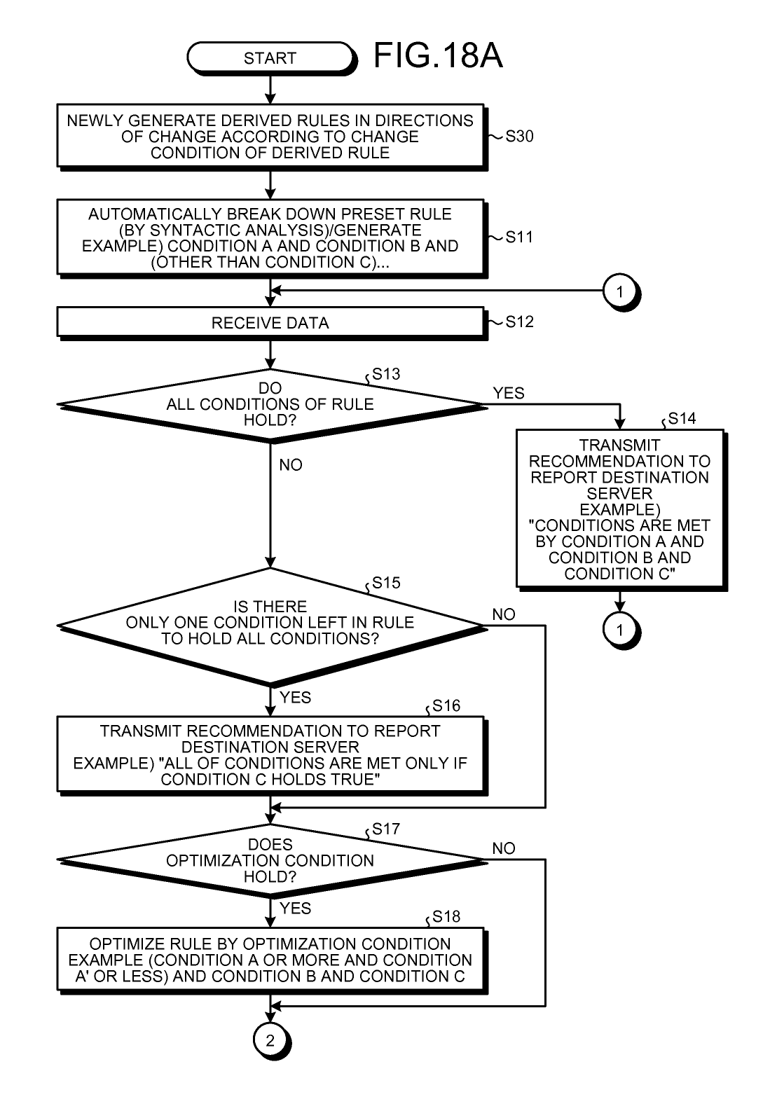

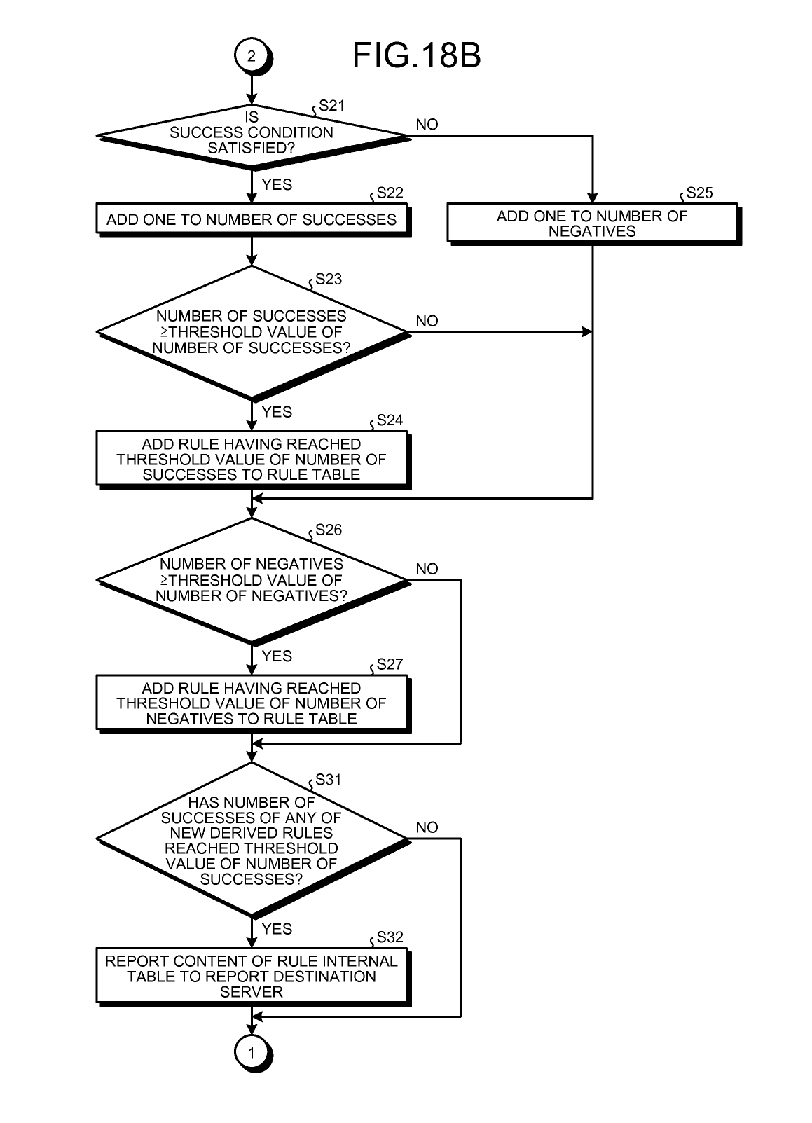

Next, with reference to FIGS. 18A and 18B, the procedure of a data extraction process will be described. FIGS. 18A and 18B are flowcharts illustrating the procedure of a data extraction process according to the fourth embodiment. Note that S11 to S27 are the same processes as those of a data extraction process according to the first embodiment, and thus, description of the processes is simplified.

First, before the operation of the system, for a derived rule whose specific condition value of a condition is to be changed among the derived rules stored in the rule internal table 133B, the detecting unit 147 generates derived rules that are derived from the derived rule (step S30). For example, the detecting unit 147 extracts a derived rule whose specific condition value of a condition is to be changed, from the rule internal table 133B. Then, for a condition indicted by the change condition 134a in the condition setting table 134 among the conditions included in the extracted derived rule, the detecting unit 147 calculates new condition values which are increased and decreased by the amount corresponding to the setting range from the condition value. Then, the detecting unit 147 generates a new derived rule where the increased condition value is the upper limit of the change condition, from the extracted derived rule. The detecting unit 147 generates a new derived rule where the decreased condition value is the lower limit of the change condition, from the extracted derived rule. Then, the detecting unit 147 adds the new generated derived rules to the rule internal table 133B.

Subsequently, a generating unit 141A automatically breaks down a preset rule by syntactic analysis, and thereby generates a derived rule (step S11). Thereafter, an extracting unit 142 receives data through a communication control I/F unit 11 (step S12). Then, the extracting unit 142 determines whether all of the conditions of the preset rule hold (step S13).

If it is determined that all of the conditions of the preset rule hold (step S13; Yes), a reporting unit 143 transmits a recommendation (report content) associated with the rule, to the report destination server apparatus 2 (step S14). Then, to receive the next data, the data extraction process transitions to step S12.

On the other hand, if it is determined that not all of the conditions of the preset rule hold (step S13; No), the extracting unit 142 determines whether there is only one condition left in the rule to hold all of the conditions (step S15). For example, the extracting unit 142 determines whether all of the conditions of the derived rule generated by the generating unit 141A hold.

If it is determined that there is only one condition left to hold all of the conditions (step S15; Yes), the reporting unit 143 transmits a recommendation (report content) associated with the derived rule, to the report destination server apparatus 2 (step S16). On the other hand, if it is determined that there is not only one condition left to hold all of the conditions (step S15; No), the extracting unit 142 moves to step S17.

At step S17, an optimizing unit 144A determines whether the optimization condition holds (step S17). If it is determined that the optimization condition does not hold (step S17; No), the data extraction process transitions to step S21. On the other hand, if it is determined that the optimization condition holds (step S17; Yes), the optimizing unit 144A optimizes the derived rule by the optimization condition (step S18).

Subsequently, a first adding unit 145 determines whether the success condition 133f of the derived rule is satisfied (step S21). For example, the first adding unit 145 determines whether the success condition 133f of a derived rule whose conditions are all matched among the derived rules stored in the rule internal table 133B is satisfied.

If it is determined that the success condition 133f of the derived rule whose conditions are all matched is satisfied (step S21; Yes), the first adding unit 145 adds one to the number of successes 133g (step S22). Then, the first adding unit 145 determines whether the number of successes 133g is greater than or equal to the threshold value of the number of successes (step S23). Note that since the new derived rules generated before the operation of the system are not targets for addition to a rule table 131, a determination process is not performed on the new derived rules. If it is determined that the number of successes 133g is not greater than or equal to the threshold value of the number of successes (step S23; No), the first adding unit 145 transitions to step S26.

On the other hand, if it is determined that the number of successes 133g is greater than or equal to the threshold value of the number of successes (step S23; Yes), the first adding unit 145 adds the derived rule having reached the threshold value of the number of successes, to the rule table 131 (step S24). Namely, when the number of successes for the success condition has reached the preset threshold value, the first adding unit 145 adds the corresponding derived rule to the rule table 131, as a valid rule. Then, the first adding unit 145 transitions to step S26.

At step S21, if it is determined that the success condition 133f of the derived rule whose conditions are all matched is not satisfied (step S21; No), a second adding unit 146 adds one to the number of negatives 133h (step S25). Then, the second adding unit 146 transitions to step S26.

At step S26, the second adding unit 146 determines whether the number of negatives 133h is greater than or equal to the threshold value of the number of negatives (step S26). Note that since the new derived rules generated before the operation of the system are not targets for addition to the rule table 131, a determination process is not performed on the new derived rules. If it is determined that the number of negatives 133h is not greater than or equal to the threshold value of the number of negatives (step S26; No), to receive the next data, the data extraction process transitions to step S31.

On the other hand, if it is determined that the number of negatives 133h is greater than or equal to the threshold value of the number of negatives (step S26; Yes), the second adding unit 146 adds the derived rule having reached the threshold value of the number of negatives, to the rule table 131 (step S27). Namely, when the number of times the result of the success condition has become negative has reached the preset threshold value, the second adding unit 146 adds the corresponding derived rule to the rule table 131, as a valid rule.

Subsequently, the detecting unit 147 determines whether the number of successes 133g of any of the new derived rules generated before the operation of the system has reached the threshold value of the number of successes (step S31). If it is determined that the number of successes 133g of any of the new derived rules has not reached the threshold value of the number of successes (step S31; No), to receive the next data, the data extraction process transitions to step S12.

On the other hand, if it is determined that the number of successes 133g of any of the new derived rules has reached the threshold value of the number of successes (step S31; Yes), the detecting unit 147 reports the content of the rule internal table 133B to the report destination server apparatus 2 (step S32). Then, to receive the next data, the data extraction process transitions to step S12.

### Advantageous Effect of the Fourth Embodiment

According to the fourth embodiment, when a derived rule which is automatically generated by changing a condition of a preset rule is a derived rule whose specific threshold value of a condition is to be changed, the server apparatus 1 generates new derived rules in the directions of change according to the change condition of the derived rule. Then, when the new generated derived rules include a derived rule that matches a success condition, the server apparatus 1 reports the presence of the derived rule to the report destination server apparatus 2. According to such a configuration, the server apparatus 1 can detect the direction of the operational environment using a new derived rule which is derived from a derived rule. As a result, in the report destination server apparatus 2, the user can review the current rule from the direction of the operational environment.

Program, Etc.

Note that the above-described embodiments describe the case of using the CEP system 9 for stock trading prediction. However, the CEP system 9 is not limited thereto, and can be used for an object that extracts data based on a rule and performs analysis based on the extracted data.

Note also that although, in the above-described embodiments, stock prices, closing exchange rates, and gasoline prices are used as conditions and success conditions, the conditions and the success conditions are not limited thereto, and any can be used as long as they can be used for prediction.

Note also that the server apparatus 1 can be implemented by installing functions, such as the above-described control unit 14 and storage unit 13, on an information processing apparatus, such as a known personal computer or workstation.

Note also that each component of the apparatuses illustrated in the drawings does not necessarily need to be physically configured in the manner illustrated in the drawings. Specifically, specific modes of division and integration of the apparatuses are not limited to those illustrated in the drawings, and all or some of the components can be configured by functionally or physically distributing or integrating them in arbitrary units, according to various loads, usage conditions, etc. For example, the optimizing unit 144A and the first adding unit 145 may be integrated into one unit. On the other hand, the optimizing unit 144A may be divided into a first optimizing unit that optimizes a condition in the rule table 131; and a second optimizing unit that optimizes a condition in the rule internal table 133. In addition, the rule table 131, the optimization condition table 132, and the rule internal table 133 may be connected via a network, as external apparatuses to the server apparatus 1.

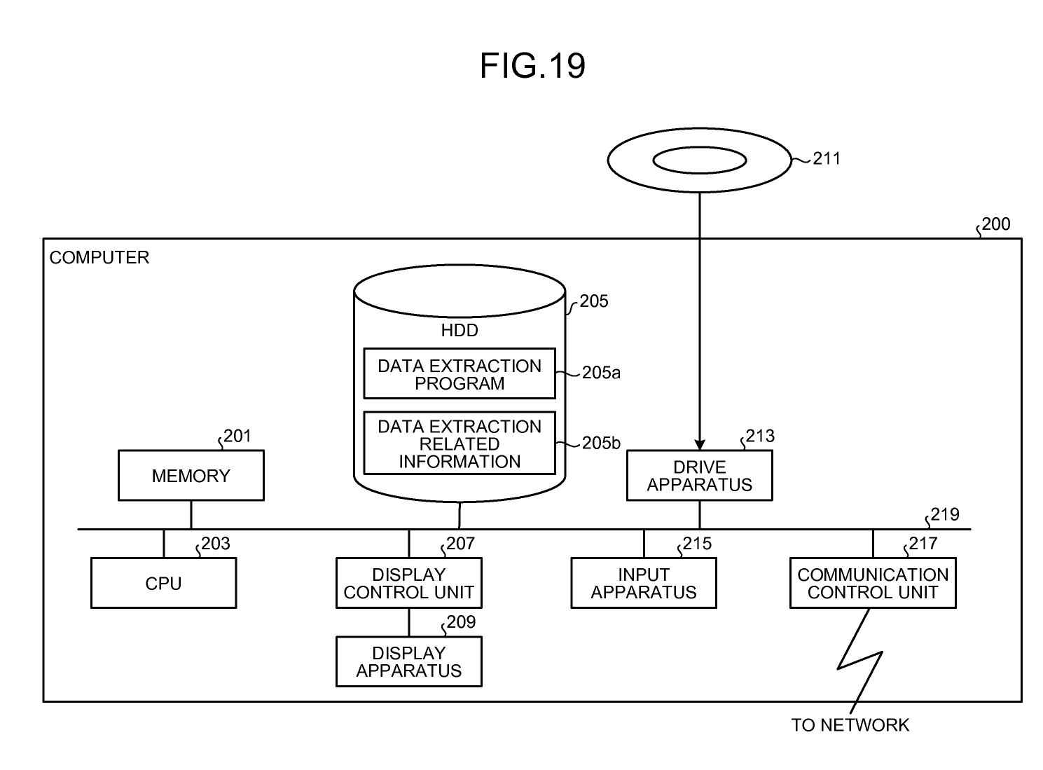

Note also that various types of processes described in the above-described embodiments can be implemented by causing a computer such as a personal computer or a workstation to execute a program prepared in advance. Now, an example of a computer that executes a data extraction program which implements the same functions as those of the server apparatus 1 illustrated in FIG. 6 will be described below. FIG. 19 is a diagram illustrating an example of a computer that executes a data extraction program.

As illustrated in FIG. 19, a computer 200 includes a CPU 203 that performs various types of computation processes; an input apparatus 215 that accepts an input of data from a user; and a display control unit 207 that controls a display apparatus 209. In addition, the computer 200 includes a drive apparatus 213 that reads a program, etc., from a storage medium; and a communication control unit 217 that gives and receives data to/from another computer through a network. In addition, the computer 200 includes a memory 201 that temporarily stores various types of information; and an HDD 205. The memory 201, the CPU 203, the HDD 205, the display control unit 207, the drive apparatus 213, the input apparatus 215, and the communication control unit 217 are connected to each other by a bus 219.

The drive apparatus 213 is, for example, an apparatus for a removable disk 211. The HDD 205 stores a data extraction program 205a and data extraction related information 205b.

The CPU 203 reads the data extraction program 205a and expands the data extraction program 205a in the memory 201 and then executes the data extraction program 205a as processes. The processes correspond to the functional units of the server apparatus 1. The data extraction related information 205b corresponds to the rule table 131, the optimization condition table 132, and the rule internal table 133. For example, the removable disk 211 stores various information such as the data extraction program 205a.

Note that the data extraction program 205a does not necessarily need to be stored on the HDD 205 from the beginning. For example, the program is stored in a “portable physical medium”, such as a flexible disk (FD), a CD-ROM, a DVD disk, a magneto-optical disk, or an IC card, which is inserted into the computer 200. Then, the computer 200 may read the data extraction program 205a from the medium and execute the data extraction program 205a.

According to one aspect of the data extraction program disclosed in the present application, a set rule can be changed to an appropriate rule.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing therein a data extraction program that causes a computer to execute a process comprising:
performing first data extraction by first rule and second data extraction by a plurality of second rules, the plurality of second rules being generated from the first rule; and
notifying an existence of notifying rule, when the plurality of second rules include a notifying rule that matches a specific condition.

2. The non-transitory computer-readable recording medium according to claim 1, wherein the performing includes performing the second data extraction by the plurality of second rules generated by changing a condition from the first rule.

3. The non-transitory computer-readable recording medium according to claim 1, wherein the notifying includes notifying, when the first data extraction fails and the plurality of second rules include a second rule by which the second data extraction is succeeded, an existence of the second rule.

4. The non-transitory computer-readable recording medium according to claim 1, the process further comprises
adding, when the plurality of second rules include a second rule that matches a specific first condition, the second rule to a normal rule.

5. The non-transitory computer-readable recording medium according to claim 4, wherein the adding includes adding, when a number of times the specific first condition is satisfied is greater than a predetermined threshold value, the second rule to the normal rule.

6. The non-transitory computer-readable recording medium according to claim 5, the process further comprises
generating, when the second rule matches a specific second condition, a new third rule where the second rule is changed in a direction of change corresponding to the second condition.

7. The non-transitory computer-readable recording medium according to claim 4, wherein the adding includes adding, when a number of times a condition negating the specific first condition is satisfied is greater than a predetermined threshold value, the second rule to the normal rule.

8. The non-transitory computer-readable recording medium according to claim 4, the process further comprises
when the second rule generated by changing a condition from the first rule is a second rule whose specific threshold value of a condition is to be changed, generating third rules from the second rule in directions of change according to the change condition of the second rule; and
notifying, when the generated third rules include a second rule that matches the specific first condition, an existence of the second rule.

9. A server apparatus comprising:
a processor; and
a memory, wherein the processor executes:
performing first data extraction by first rule and second data extraction by a plurality of second rules, the plurality of second rules being generated from the first rule; and
notifying an existence of notifying rule, when the plurality of second rules include a notifying rule that matches a specific condition.

10. A data extraction method to be performed by a computer, the method comprising:
performing first data extraction by first rule and second data extraction by a plurality of second rules, the plurality of second rules being generated from the first rule using a processor; and
notifying an existence of notifying rule, when the plurality of second rules include a notifying rule that matches a specific condition using the processor.
